(19) United States
(12) Patent Application Publication
(10) Pub. No.: US 2025/0351168 A1
(43) Pub. Date: Nov. 13, 2025

(54) LOW OVERHEAD NON-TERRESTRIAL NETWORK (NTN) TIME DIVISION DUPLEX

(71) Applicant: Telefonaktiebolaget LM Ericsson (publ), Stockholm (SE)

(72) Inventors: Olof LIBERG, Stockholm (SE); Johan RUNE, Stockholm (SE); Stefan ERIKSSON LÖWENMARK, Stockholm (SE); Gerardo Agni MEDINA ACOSTA, Stockholm (SE); Ratheesh Kumar MUNGARA, Stockholm (SE)

(21) Appl. No.: 19/203,929

(22) Filed: May 9, 2025

Related U.S. Application Data
(60) Provisional application No. 63/645,647, filed on May 10, 2024.

(51) Int. Cl. H04W 74/0808; H04L 5/14; H04W 76/20; H04W 84/06

(52) U.S. Cl. CPC H04W 74/0808; H04L 5/1469; H04W 76/20; H04W 84/06

(57) ABSTRACT

A method, network node and user equipment (UE) for low overhead non-terrestrial network (NTN) time division duplex operation are disclosed. According to one aspect, a method in a UE served by a satellite based network node in a non-terrestrial satellite communication network for a radio access technology using time division duplex (TDD) is provided. The method includes receiving an uplink-downlink (UL-DL) configuration to configure a set of back-to-back DL subframes followed by a first gap encompassing one or more radio frames, and a set of back-to-back UL subframes followed by a second gap encompassing one or more radio frames, the set of back-to-back DL subframes and the first gap configured to alternate with the set of back-to-back UL subframes and the second gap every n-th radio frame. The method includes receiving DL transmissions and transmit UL transmissions in accordance with the UL-DL configuration

### CROSS-REFERENCE TO RELATED APPLICATION

This application is related to and claims priority to U.S. Provisional Patent Application No. 63/645,647, filed May 10, 2024, entitled LOW OVERHEAD NTN TIM E DIVISION DUPLEX, the entire contents of which are incorporated herein by reference.

### TECHNICAL FIELD

The present disclosure relates to wireless communications, and in particular, to low overhead Non-Terrestrial Network (NTN) time division duplex (TDD) operation.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile user equipments (UE), as well as communication between network nodes and between UEs. The 3GPP is also developing standards for Sixth Generation (6G) wireless communication networks. 3GPP support since 3GPP Technical Release 17 (3GPP Rel-17) NR, LTE-machine type communication (MTC) and narrowband Internet of things (NB-IoT) based Non-Terrestrial Networks (NTN). NTN includes both satellite communication and communications using high-altitude platforms (HAPS). Although the focus of this disclosure is satellite communication, the principles may also be applied to a HAPS network. A satellite radio access network usually includes the following components:
A satellite that refers to a space-borne platform;
An earth-based gateway that connects the satellite to a base station or a core network, depending on the choice of architecture;
A feeder link that refers to the link between a gateway and a satellite; and
A service link that refers to the link between a satellite and a UE.

Depending on the orbit altitude, a satellite may be categorized as low earth orbit (LEO), medium earth orbit (MEO), or geostationary earth orbit (GEO) satellite:
LEO: typical heights ranging from 500-1,500 km, with orbital periods ranging from 90-120 minutes;
MEO: typical heights ranging from 5,000-25,000 km, with orbital periods ranging from 3-15 hours; and
GEO: height at about 35,786 km, with an orbital period matching the rotation of earth, i.e., of 24 hours.

A communication satellite typically generates several beams over a given area. The footprint of a beam on earth is usually in an elliptic shape. Each beam typically provides coverage to a cell in a 5G or 4G network. The footprint of a beam is also often referred to as a spotbeam. The footprint of a beam may move over the earth surface with the satellite movement or may be earth-fixed due to a beam pointing mechanism used by the satellite to compensate for its motion (also referred to as quasi-earth-fixed beam/cell deployment). The size of a spotbeam depends on the system design, which may range from tens of kilometers to a few thousands of kilometers. It is expected that a beam will cover one cell (i.e., a one-to-one relation between beams and cells) in a typical deployment scenario. But the 3GPP standard does not preclude using multiple beams per cell.

FIG. 1 is a diagram of an example architecture of a satellite network according to the so-called transparent architecture where the base station is part of the gateway. Another popular architecture is the regenerative architecture where the base station is located on board the satellite. The depicted elevation angle of the service link is important as it impacts the distance between the satellite and the device, and the velocity of the satellite relative to the device.

The following is from 3GPP Technical Standard (TS) 38.300 (V18.1.0):

### Non-Terrestrial Networks

### Overview

FIG. 2 illustrates an example of a Non-Terrestrial Network (NTN) providing non-terrestrial NR access to the UE by means of an NTN payload and an NTN Gateway, depicting a service link between the NTN payload and a UE, and a feeder link between the NTN Gateway and the NTN payload.
NOTE 1: FIG. 2 illustrates an NTN; RAN 4 aspects are out of scope.

The NTN payload transparently forwards the radio protocol received from the UE (via the service link) to the NTN Gateway (via the feeder link) and vice-versa. The following connectivity is supported by the NTN payload:
An NTN gateway may serve multiple NTN payloads;
An NTN payload may be served by multiple NTN gateways.
NOTE 2: In this release, the NTN-payload may change the carrier frequency, before re-transmitting it on the service link, and vice versa (respectively on the feeder link).

For NTN, the following applies in addition to Network Identities as described in clause 8.2:
A Tracking Area corresponds to a fixed geographical area. Any respective mapping is configured in the RAN;
A Mapped CellID as specified in clause 16.14.5.

Three types of service links are supported:
Earth-fixed: provisioned by beam(s) continuously covering the same geographical areas all the time (e.g., the case of GSO satellites);
Quasi-Earth-fixed: provisioned by beam(s) covering one geographic area for a limited period and a different geographic area during another period (e.g., the case of NGSO satellites generating steerable beams);
Earth-moving: provisioned by beam(s) whose coverage area slides over the Earth surface (e.g., the case of NGSO satellites generating fixed or non-steerable beams).

With NGSO satellites, the gNB may provide either quasi-Earth-fixed service link or Earth-moving service link, while a gNB operating with a GSO satellite may provide an Earthfixed service link or a quasi-Earth-fixed service link.

In this release, the UE supporting NTN is GNSS-capable.

In NTN, the distance refers to Euclidean distance.

The following is from 3GPP TS 38.108 (V18.2.0):

### SAN Type 1-H

For SAN type 1-H, the requirements are defined for two points of reference, signified by radiated requirements and conducted requirements. See FIG. 3. Radiated characteristics are defined over the air (OTA), where the radiated interface is referred to as the Radiated Interface Boundary (RIB). Radiated requirements are also referred to as OTA requirements. The (spatial) characteristics in which the OTA requirements apply are detailed for each requirement.

Conducted characteristics are defined at individual or groups of TAB connectors at the transceiver array boundary, which is the conducted interface between the transceiver unit array and the composite antenna.

The transceiver unit array is part of the composite transceiver functionality for receiving and transmitting modulated signals to ensure radio links with users.

The satellite payload includes a transceiver unit array and a composite antenna array. The transceiver unit array contains an implementation specific number of transmitter units and an implementation specific number of receiver units.

The composite antenna contains a radio distribution network (RDN) and an antenna array. The R D N is a linear passive network which distributes the RF power generated by the transceiver unit array to the antenna array, and/or distributes the radio signals collected by the antenna array to the transceiver unit array, in an implementation specific way.

How a conducted requirement is applied to the transceiver array boundary is detailed in the respective requirement clause.

### SAN Type 1-O

For SAN type 1-O, the radiated characteristics are defined over the air (OTA), where the operating band specific radiated interface is referred to as the Radiate Interface Boundary (RIB). Radiated requirements are also referred to as OTA requirements. The (spatial) characteristics in which the OTA requirements apply are detailed for each requirement. See FIG. 4.

As illustrated in FIG. 5, a satellite may support a set of beams for providing coverage to a set of cells on earth. To provide continuous coverage, adjacent beams are often configured to overlap, which creates significant inter-cell interference.

A satellite is power limited, meaning that the power available in the satellite may limit the number of simultaneous beams and thus, the coverage area it supports. In 3GPP Rel-19, the 3GPP is investigating methods that allow a satellite to increase its coverage area. One potential solution is that the satellite moves (or hops) its beams within its field of view so that one single beam supports different cells at different time instances. FIG. 5 illustrates a method of hopping a beam between three cells over time. Another way to view this concept is that a satellite has multiple beams of which only a subset is active at any one time, i.e., what moves (or hops) is the property of being active, not the beam itself (meaning that a given beam will toggle between being active and not being active). For a quasi-earth-fixed deployment with one beam per cell, the concept may advantageously be described as cells toggling between being active and being inactive.

### Duplex Arrangement

Most satellite networks operate their NTN over paired frequency bands using Frequency Division Duplex (FDD). At least one vendor does however operate their system over a single unpaired band using Time Division Duplex (TDD) and support for NR NTN using TDD in 3GPP Rel-19 has been considered.

In a TDD system, uplink (UL) and downlink (DL) transmissions are multiplexed in time on a single carrier. Both the base station and the UEs in a TDD network therefore use half-duplex and switch between uplink and downlink transmission.

As the TDD frame structure is switching from downlink (DL) to uplink (UL) transmissions, a guard-period (GP) is used to prevent the uplink transmissions from interfering with the downlink transmissions. FIG. 6 illustrates the interference between a pair of cell edge UEs in case of absence of a guard period (GP). FIG. 6 shows that the timing-advance (TA) configured in UE1 and UE2 to overcome their respective round-trip times (RTT) and achieve UL frame alignment, creates the interference. If UE1 would transmit in its first UL slot while UE2 receives in the last DL slot, UE1 would interfere with the reception of UE2. It is further clear that neither of the UEs may simultaneously transmit in the first UL slot and receive in the last DL slot without creating self-interference.

For these reasons, 3GPP has introduced a guard-period (GP) between DL and UL slots. This GP should prevent the above-mentioned interference and be dimensioned to at least the maximum round-trip time (RTT) provided by a base station (BS). FIG. 7 illustrates the GP between DL transmissions and UL receptions of the BS.

In a satellite network, the GP needs to be large to support the long round-trip times observed in the NTN due to the significant distance between earth and the satellite.

So far, the 3GPP has not specified support for NTN TDD. Thus, there is a need to consider how NTN TDD may be efficiently supported, e.g., in combination with the 3GPP Rel-19 goal to increase the NTN coverage, and considering the impacts of the large UE-gNB RTT in NTN.

### SUMMARY

Some embodiments advantageously provide methods and network nodes for low overhead NTN time division duplex operation.

Some embodiments include resource-efficient methods for supporting increased satellite coverage and reduced intercell interference in a TDD NTN by introducing a time-reuse, or beam hopping, across beams/cells. Some methods disclosed herein minimize the overhead due to the TDD GP.

In some embodiments, a sequence of DL transmissions are sent to a group of cells.

Then, a single GP is transmitted, followed by a sequence of UL transmissions. Some embodiments provide optimization of the GP length such as by adapting the GP according to the actual distance between the satellite and the cells on the ground, which varies over time with the satellite motion. Some embodiments include methods by which the need for introducing a GP specifically for the purpose of mitigating interference caused by TDD UL/DL shifts is eliminated.

Some embodiments minimize the overhead stemming from the TDD GP in a NTN.

According to one aspect, a method performed by a user equipment (UE) served by a satellite based network node in a non-terrestrial satellite communication network for a radio access technology using time division duplex is provided. The method includes: receiving an uplink-downlink (UL-DL) configuration to configure a set of back-to-back DL subframes followed by a first gap encompassing one or more radio frames, and a set of back-to-back UL subframes followed by a second gap encompassing one or more radio frames, the set of back-to-back DL subframes and the first gap configured to alternate with the set of back-to-back UL subframes and the second gap every n-th radio frame. The method includes receiving DL transmissions and transmitting UL transmissions in accordance with the UL-DL configuration.

According to this aspect, in some embodiments the first and second gaps include a guard period between DL transmissions to a plurality of cells and UL transmissions from the plurality of cells. In some embodiments, an order of cells for the DL transmissions and the UL transmissions across the plurality of cells is configured by radio resource control (RRC) signaling. In some embodiments, an order of UEs for the UL and DL transmissions is configured by radio resource control (RRC) signaling based at least in part on a priority. In some embodiments, an order in which cells and UEs are configured for the DL and UL transmissions is determined to minimize the guard period between the DL transmissions and the UL transmissions. In some embodiments, minimization of the guard period is based at least in part on scheduling DL and UL transmissions in a cell of the plurality of cells for which a propagation is delay is smallest before and after the guard period. In some embodiments, the guard period is at least as long as a sum of a propagation delay in a first cell of a last DL transmission before the guard period and a propagation delay in a second cell of a first UL transmission after the guard period. In some embodiments, the guard period is less than a sum of a propagation delay in a first cell of a last DL transmission before the guard period and a propagation delay in a second cell of a first UL transmission after the guard period. In some embodiments, the gap includes a guard period between UL transmissions and DL transmissions, the guard period being determined to be at least a maximum round trip time (RTT) across a plurality of cells served by a satellite. In some embodiments, a duration of DL transmission is one of fixed and dynamically configured. In some embodiments, the UL-DL configuration is defined for a narrow band Internet of things (NB-IoT) frame structure. In some embodiments, the NB-IoT frame structure spans a plurality of radio frames.

According to another aspect, a UE served by a satellite based network node in a non-terrestrial satellite communication network for a radio access technology using time division duplex is provided. The UE includes processing circuitry configured to: receive an uplink-downlink (UL-DL) configuration to configure a set of back-to-back DL subframes followed by a first gap encompassing one or more radio frames, and a set of back-to-back UL subframes followed by a second gap encompassing one or more radio frames, the set of back-to-back DL subframes and the first gap configured to alternate with the set of back-to-back UL subframes and the second gap every n-th radio frame. The processing circuitry is also configured to receive DL transmissions and transmit UL transmissions in accordance with the UL-DL configuration.

According to this aspect, in some embodiments, the first and second gaps include a guard period between DL transmissions to a plurality of cells and UL transmissions for the plurality of cells. In some embodiments, an order of cells for the DL transmissions and the UL transmissions across the plurality of cells is configured by radio resource control (RRC) signaling. In some embodiments, an order of UEs for the UL and DL transmissions is configured by radio resource control (RRC) signaling based at least in part on a priority. In some embodiments, an order in which cells and UEs are configured for the UL and DL transmissions is determined to minimize the guard period between the DL transmissions and the UL transmissions. In some embodiments, minimization of the guard period is based at least in part on scheduling DL and UL transmissions in a cell of the plurality of cells for which a propagation is delay is smallest before and after the guard period. In some embodiments, the guard period is at least as long as a sum of a propagation delay in a first cell of a last DL transmission before the guard period and a propagation delay in a second cell of a first UL transmission after the guard period. In some embodiments, the guard period is less than a sum of a propagation a delay in a first cell of a last DL transmission before the guard period and a propagation delay in a second cell of a first UL transmission after the guard period. In some embodiments, the first gap and the second gap include a guard period between UL transmissions and DL transmissions, the guard period being determined to be at least a maximum round trip time (RTT) across a plurality of cells served by a satellite. In some embodiments, a duration of DL transmission is one of fixed and dynamically configured. In some embodiments, the UL-DL configuration is defined for a narrow band Internet of things (NB-IoT) frame structure. In some embodiments, the NB-IoT frame structure spans a plurality of radio frames.

According to yet another aspect, a method performed by a satellite based network node in a non-terrestrial satellite communication network configured to serve a plurality of user equipments (UEs) for a radio access technology using time division duplex is provided. The method includes: transmitting an uplink-downlink (UL-DL) configuration to configure a set of back-to-back DL subframes followed by a first gap encompassing one or more radio frames, and a set of back-to-back UL subframes followed by a second gap encompassing one or more radio frames, the set of back-to-back DL subframes and the first gap configured to alternate with the set of back-to-back UL subframes and the second gap every n-th radio frame. The method also includes transmitting DL transmissions and receiving UL transmissions in accordance with the UL-DL configuration.

According to this aspect, in some embodiments, the first and second gaps include a guard period between DL transmissions to a plurality of cells and UL transmissions from the plurality of cells. In some embodiments, an order in which cells and UEs are configured for the DL and UL transmissions is determined to minimize the guard period between the DL transmissions and the uplink transmissions. In some embodiments, the UL-DL configuration is defined for a narrow band Internet of things (NB-IoT) frame structure. In some embodiments, the NB-IoT frame structure spans a plurality of radio frames.

According to another aspect, a satellite based network node in a non-terrestrial satellite communication network configured to serve a plurality of user equipments (UEs) for a radio access technology using time division duplex is provided. The network node includes processing circuitry configured to: transmit an uplink-downlink (UL-DL) configuration to configure a set of back-to-back DL subframes followed by a first gap encompassing one or more radio frames, and a set of back-to-back UL subframes followed by a second gap encompassing one or more radio frames, the set of back-to-back DL subframes and the first gap configured to alternate with the set of back-to-back UL subframes and the second gap every n-th radio frame. The processing circuitry is also configured to transmit DL transmissions and receive UL transmissions in accordance with the UL-DL configuration.

According to this aspect, in some embodiments, the first and second gaps include a guard period between DL transmissions to a plurality of cells and UL transmissions from the plurality of cells. In some embodiments, an order in which cells and UEs are configured for the DL and UL transmissions is determined to minimize the guard period between the DL transmissions and the uplink transmissions. In some embodiments, the UL-DL configuration is defined for a narrow band Internet of things (NB-IoT) frame structure. In some embodiments, the NB-IoT frame structure spans a plurality of radio frames.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is an example architecture of a satellite network with bent pipe transponders;

FIG. 2 is an NTN architecture;

FIG. 3 is an example satellite access node;

FIG. 4 is another example satellite access node;

FIG. 5 illustrates a method of hopping a beam between three cells overtime;

FIG. 6 shows TDD transmissions not enforcing a guard period;

FIG. 7 shows TDD transmissions including a guard period;

FIG. 8 is a schematic diagram of an example network architecture illustrating a communication system according to principles disclosed herein;

FIG. 9 is a block diagram of a network node in communication with a user equipment over a wireless connection according to some embodiments of the present disclosure;

FIG. 10 is a block diagram of a virtualization environment constructed in accordance with principles disclosed herein;

FIG. 11 is a flowchart of an example process in a network node for low overhead NTN time division duplex operation according to some embodiments of the present disclosure;

FIG. 12 is a flowchart of an example process in a network node for low overhead NTN time division duplex operation according to some embodiments of the present disclosure;

FIG. 13 is a flowchart of an example process in a user equipment for low overhead NTN time division duplex operation according to some embodiments of the present disclosure;

FIG. 14 is a spectrally efficient NTN TDD time reuse pattern across two cells according to some embodiments;

FIG. 15 is an NTN TDD time reuse pattern across two cells with a guard period (GP) according to some embodiments;

FIG. 16 is an NTN TDD time reuse pattern across two cells with a guard period (GP) according to some embodiments;

FIG. 17 is an NTN TDD time reuse pattern across two cells with a guard period (GP) according to some embodiments;

FIG. 18 is an example of spatial separation of antenna arrays according to principles disclosed herein;

FIG. 19 shows simultaneous DL and UL transmissions to beam subsets with spatial separation; and

FIG. 20 is an example antenna architecture with spatially isolated antenna arrays according to principles disclosed herein.

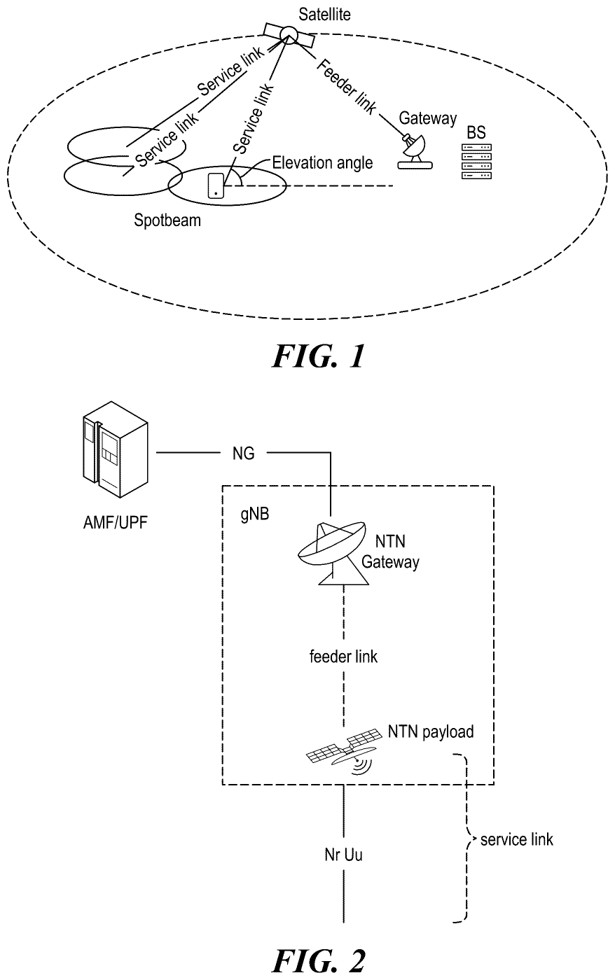

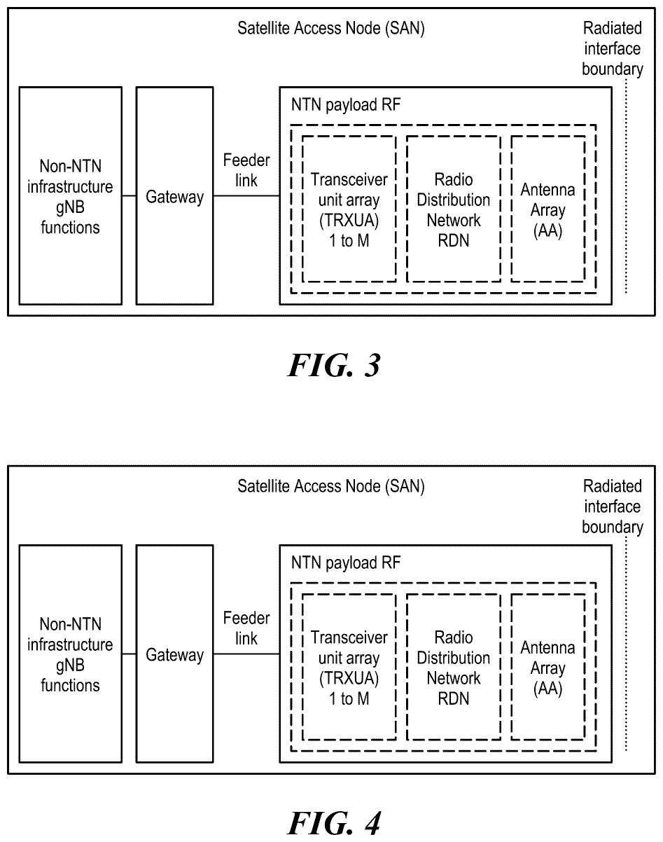

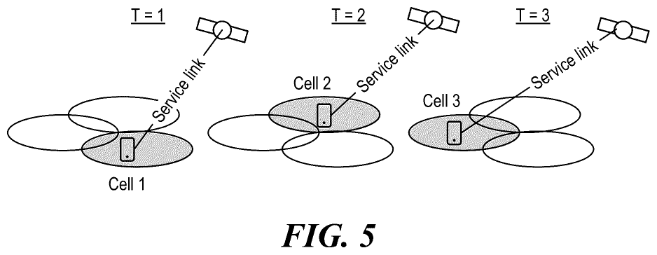

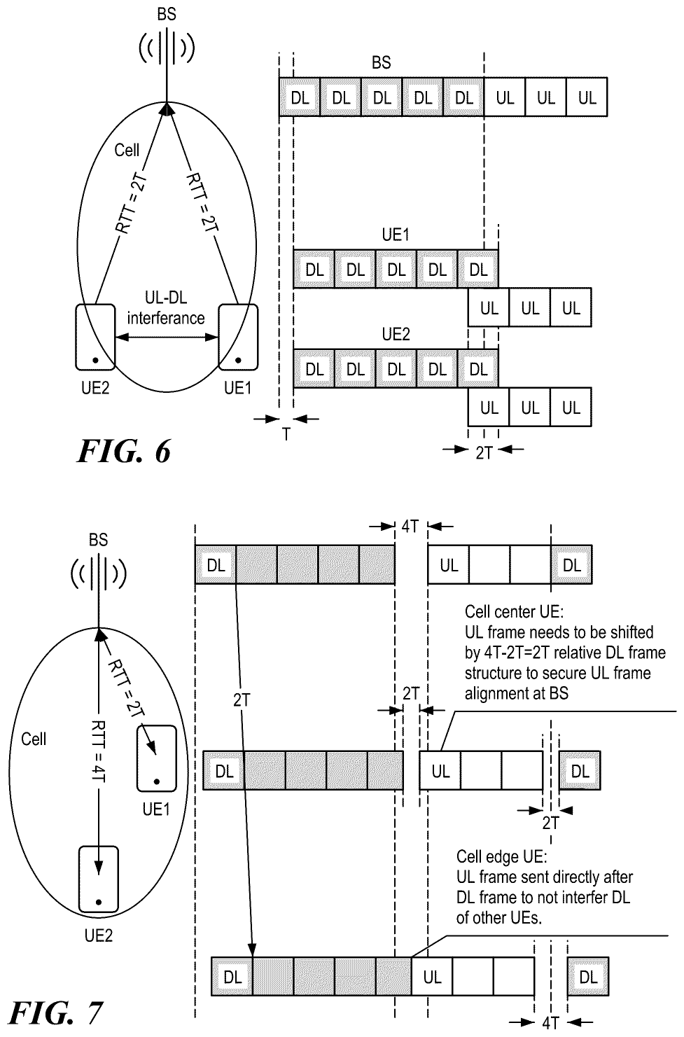

### DETAILED DESCRIPTION

Before describing in detail example embodiments, it is noted that the embodiments reside primarily in combinations of apparatus components and processing steps related to low overhead NTN time division duplex operation. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

The term “network node” used herein may be any kind of network node comprised in a radio network which may further comprise any of a base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a user equipment (UE) such as a wireless device (WD) or a radio network node.

In some embodiments, the non-limiting terms wireless device (WD) or a user equipment (UE) are used interchangeably. The UE herein may be any type of user equipment capable of communicating with a network node or another UE over radio signals, such as a wireless device (WD). The UE may also be a radio communication device, target device, device to device (D2D) UE, machine type UE or UE capable of machine to machine communication (M2M), low-cost and/or low-complexity UE, a sensor equipped with UE, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), relay node, access point, radio access point, Remote Radio Unit (RRU) Remote Radio Head (RRH).

The term “satellite” or “NTN node” refers to a non-terrestrial node that may be a satellite in space or an airborne vehicle above the Earth within the Earth's atmosphere. Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a user equipment or a network node may be distributed over a plurality of user equipments and/or network nodes. In other words, it is contemplated that the functions of the network node and user equipment described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments are directed to low overhead NTN time division duplex operation.

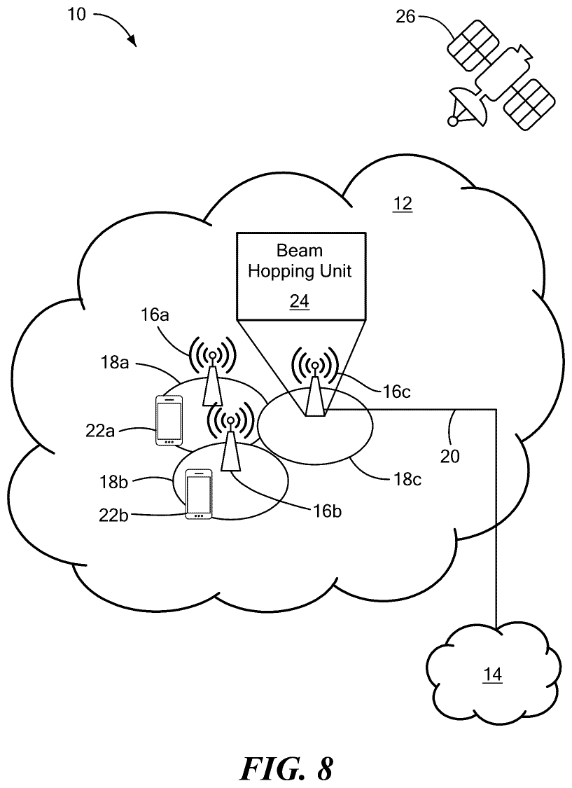

Returning to the drawing figures, in which like elements are referred to by like reference numerals, there is shown in FIG. 8 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first user equipment (UE) 22a located in coverage area 18a is configured to wirelessly connect to, or be paged by, the corresponding network node 16a. A second UE 22b in coverage area 18b is wirelessly connectable to the corresponding network node 16b. While a plurality of UEs 22a, 22b (collectively referred to as user equipments 22) are illustrated in this example, the disclosed embodiments are equally applicable to a situation where a sole UE is in the coverage area or where a sole UE is connecting to the corresponding network node 16. Note that although only two UEs 22 and three network nodes 16 are shown for convenience, the communication system may include many more UEs 22 and network nodes 16.

Also, it is contemplated that a UE 22 may be in simultaneous communication and/or configured to separately communicate with more than one network node 16 and more than one type of network node 16. For example, a UE 22 may have dual connectivity with a network node 16 that supports LTE and the same or a different network node 16 that supports NR. As an example, UE 22 may be in communication with an eNB for LTE/E-UTRAN and a gNB for NR/N G-RAN.

A network node 16 (eNB or gNB) is configured to include a beam hopping unit 24 which may be configured to determine a beam hopping coordination pattern of downlink, DL, transmissions and uplink, UL, receptions to a plurality of cells. One or more of the UEs 22 and the network nodes 16 are configured to communicate with an NTN node 26 such as a satellite. In some embodiments, the satellite may include the beam hopping unit 24. The beam hopping unit 24 may be configured to configure a set of back-to-back DL subframes followed by a first gap encompassing one or more radio frames, and a set of back-to-back UL subframes followed by a second gap encompassing one or more radio frames, the set of back-to-back DL subframes and the first gap configured to alternate with the set of back-to-back UL subframes and the second gap every n-th radio frame.

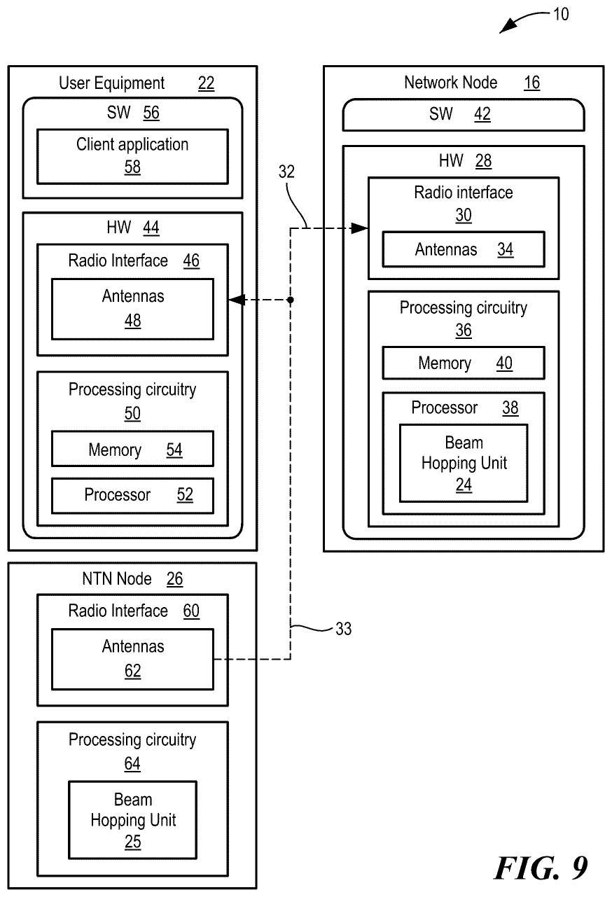

Example implementations, in accordance with an embodiment, of the UE 22 and network node 16 discussed in the preceding paragraphs will now be described with reference to FIG. 9.

The communication system 10 includes a network node 16 provided in a communication system 10 and including hardware 28 enabling it to communicate with the UE 22. The hardware 28 may include a radio interface 30 for setting up and maintaining at least a wireless connection 32 with a UE 22 located in a coverage area 18 served by the network node 16. The radio interface 30 may be formed as or may include, for example, one or more R F transmitters, one or more R F receivers, and/or one or more R F transceivers. The radio interface 30 includes an array of antennas 34 to radiate and receive signal(s) carrying electromagnetic waves.

In the embodiment shown, the hardware 28 of the network node 16 further includes processing circuitry 36. The processing circuitry 36 may include a processor 38 and a memory 40. In particular, in addition to or instead of a processor, such as a central processing unit, and memory, the processing circuitry 36 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 38 may be configured to access (e.g., write to and/or read from) the memory 40, which may comprise any kind of volatile and/or nonvolatile memory, e.g., cache and/or buffer memory and/or RA M (Random Access Memory) and/or ROM (Read-Only Memory) and/or optical memory and/or EPROM (Erasable Programmable Read-Only Memory).

Thus, the network node 16 further has software 42 stored internally in, for example, memory 40, or stored in external memory (e.g., database, storage array, network storage device, etc.) accessible by the network node 16 via an external connection. The software 42 may be executable by the processing circuitry 36. The processing circuitry 36 may be configured to control any of the methods and/or processes described herein and/or to cause such methods, and/or processes to be performed, e.g., by network node 16. Processor 38 corresponds to one or more processors 38 for performing network node 16 functions described herein. The memory 40 is configured to store data, programmatic software code and/or other information described herein. In some embodiments, the software 42 may include instructions that, when executed by the processor 38 and/or processing circuitry 36, causes the processor 38 and/or processing circuitry 36 to perform the processes described herein with respect to network node 16. For example, processing circuitry 36 of the network node 16 may include a beam hopping unit 24 which may be configured to determine a beam hopping coordination pattern of downlink, DL, transmissions and uplink, UL, receptions to a plurality of cells. The beam hopping unit 24 may be configured to configure a set of back-to-back DL subframes followed by a first gap encompassing one or more radio frames, and a set of back-to-back UL subframes followed by a second gap encompassing one or more radio frames, the set of back-to-back DL subframes and the first gap configured to alternate with the set of back-to-back UL subframes and the second gap every n-th radio frame.

The communication system 10 further includes the UE 22 already referred to. The UE 22 may have hardware 44 that may include a radio interface 46 configured to set up and maintain a wireless connection 32 with a network node 16 serving a coverage area 18 in which the UE 22 is currently located. The radio interface 46 may be formed as or may include, for example, one or more R F transmitters, one or more R F receivers, and/or one or more RF transceivers. The radio interface 46 includes an array of antennas 48 to radiate and receive signal(s) carrying electromagnetic waves.

The hardware 44 of the UE 22 further includes processing circuitry 50. The processing circuitry 50 may include a processor 52 and memory 54. In particular, in addition to or instead of a processor, such as a central processing unit, and memory, the processing circuitry 50 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 52 may be configured to access (e.g., write to and/or read from) memory 54, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the UE 22 may further comprise software 56, which is stored in, for example, memory 54 at the UE 22, or stored in external memory (e.g., database, storage array, network storage device, etc.) accessible by the UE 22. The software 56 may be executable by the processing circuitry 50. The software 56 may include a client application 58. The client application 58 may be operable to provide a service to a human or non-human user via the UE 22.

The processing circuitry 50 may be configured to control any of the methods and/or processes described herein and/or to cause such methods, and/or processes to be performed, e.g., by UE 22. The processor 52 corresponds to one or more processors 52 for performing UE 22 functions described herein. The UE 22 includes memory 54 that is configured to store data, programmatic software code and/or other information described herein. In some embodiments, the software 56 and/or the client application 58 may include instructions that, when executed by the processor 52 and/or processing circuitry 50, causes the processor 52 and/or processing circuitry 50 to perform the processes described herein with respect to UE 22. For example, the processing circuitry may be configured to receive a configuration of a set of back-to-back DL subframes followed by a first gap encompassing one or more radio frames, and a set of back-to-back UL subframes followed by a second gap encompassing one or more radio frames, the set of back-to-back DL subframes and the first gap configured to alternate with the set of back-to-back UL subframes and the second gap every n-th radio frame; and to receive DL transmissions and transmit UL transmissions in accordance with the UL-DL configuration.

In some embodiments, the inner workings of the network node 16 and UE 22 may be as shown in FIG. 9 and independently, the surrounding network topology may be that of FIG. 8.

The wireless connection 32 between the UE 22 and the network node 16 is in accordance with the teachings of the embodiments described throughout this disclosure. More precisely, the teachings of some of these embodiments may improve the data rate, latency, and/or power consumption and thereby provide benefits such as reduced user waiting time, relaxed restriction on file size, better responsiveness, extended battery lifetime, etc. In some embodiments, a measurement procedure may be provided for the purpose of monitoring data rate, latency and other factors on which the one or more embodiments improve.

The communication system 10 includes an NTN node 26 that includes a radio interface 60 for setting up and maintaining at least a wireless connection with the network node 16 and UEs 22 located in a coverage area 18 served by the network node 16. The network node 16 may include or be in communication with a Earth-based gateway that communicates with the NTN node 26. The radio interface 60 may be formed as or may include, for example, one or more R F transmitters, one or more R F receivers, and/or one or more RF transceivers. The radio interface 60 includes an array of antennas 62 to radiate and receive signal(s) carrying electromagnetic waves on radio link 33 The NTN node 26 includes processing circuitry 64 which may include a processor, such as a central processing unit, and memory. The processing circuitry 64 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor may be configured to access (e.g., write to and/or read from) the memory, which may comprise any kind of volatile and/or nonvolatile memory, e.g., cache and/or buffer memory and/or RA M (Random Access Memory) and/or ROM (Read-Only Memory) and/or optical memory and/or EPROM (Erasable Programmable Read-Only Memory).

Thus, the NTN node 26 may have software stored internally in memory. The software may be executable by the processing circuitry 64. The processing circuitry 64 may be configured to control any of the methods and/or processes described herein and/or to cause such methods, and/or processes to be performed, e.g., by NTN 26 In some embodiments, the software may include instructions that, when executed by processing circuitry 36, causes the processing circuitry 36 to perform the processes described herein with respect to NTN node 26. For example, processing circuitry 64 of the NTN node 26 may include a beam hopping unit 25 which may be configured to determine a beam hopping coordination pattern of downlink, DL, transmissions and uplink, UL, receptions to a plurality of cells. The beam hopping unit 25 may be configured to configure a set of back-to-back DL subframes followed by a first gap encompassing one or more radio frames, and a set of back-to-back UL subframes followed by a second gap encompassing one or more radio frames, the set of back-to-back DL subframes and the first gap configured to alternate with the set of back-to-back UL subframes and the second gap every n-th radio frame.

Although FIGS. 8 and 9 show various “units” such as beam hopping unit 24 as being within a respective processor, it is contemplated that these units may be implemented such that a portion of the unit is stored in a corresponding memory within the processing circuitry. In other words, the units may be implemented in hardware or in a combination of hardware and software within the processing circuitry.

For example, in some embodiments, the communication system 10 includes one or more Open-RAN (ORAN) network nodes 16, i.e., one or more network nodes 16 may be ORAN nodes. An ORAN network node 16 is a node in the telecommunication system 10 that supports an ORAN specification (e.g., a specification published by the O-RAN Alliance, or any similar organization) and may operate alone or together with other nodes to implement one or more functionalities of any node in the telecommunication system 10, including one or more network nodes 16 in the access network 12 and/or core network nodes 14.

Examples of an ORAN network node 16 include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface.

Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 16 facilitate direct or indirect connection of user equipment (UE), such as by connecting UEs 22a, 22b, 22c, and QQ112d (one or more of which may be generally referred to as UEs 22) to the core network 14 over one or more wireless connections.

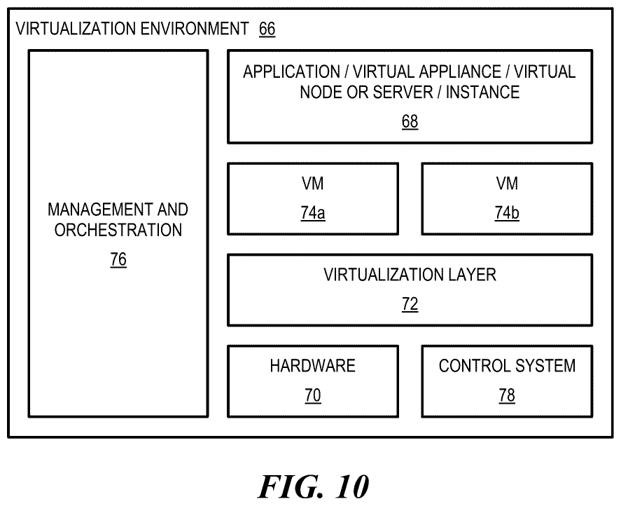

FIG. 10 is a block diagram illustrating a virtualization environment 94 in which functions implemented by some embodiments may be virtualized. In the present context, virtualizing means creating virtual versions of apparatuses or devices which may include virtualizing hardware platforms, storage devices and networking resources. As used herein, virtualization may be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 66 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 66 includes components defined by the O-RAN Alliance, such as an O-Cloud environment orchestrated by a Service Management and Orchestration Framework via an O-2 interface.

Applications 68 (which may alternatively be called software instances, virtual appliances, network functions, virtual nodes, virtual network functions, etc.) are run in the virtualization environment 66 to implement some of the features, functions, and/or benefits of some of the embodiments disclosed herein.

Hardware 70 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 72 (also referred to as hypervisors or virtual machine monitors (VMMs)), provide VMs 74a and 74b (one or more of which may be generally referred to as VMs 74), and/or perform any of the functions, features and/or benefits described in relation with some embodiments described herein. The virtualization layer 72 may present a virtual operating platform that appears like networking hardware to the VMs.

The VMs 74 comprise virtual processing, virtual memory, virtual networking or interface and virtual storage, and may be run by a corresponding virtualization layer 72. Different embodiments of the instance of a virtual appliance 68 may be implemented on one or more of VMs 74, and the implementations may be made in different ways. Virtualization of the hardware is in some contexts referred to as network function virtualization (NFV). NFV may be used to consolidate many network equipment types onto industry standard high volume server hardware, physical switches, and physical storage, which may be located in data centers, and customer premise equipment.

In the context of NFV, a VM 74 may be a software implementation of a physical machine that runs programs as if they were executing on a physical, non-virtualized machine. Each of the VMs 74, and that part of hardware 70 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 74 on top of the hardware 70 and corresponds to the application 68.

Hardware 70 may be implemented in a standalone network node with generic or specific components. Hardware 70 may implement some functions via virtualization. Alternatively, hardware 70 may be part of a larger cluster of hardware (e.g. such as in a data center or CPE) where many hardware nodes work together and are managed via management and orchestration 76, which, among others, oversees lifecycle management of applications 68. In some embodiments, hardware 70 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling may be provided with the use of a control system 78 which may alternatively be used for communication between hardware nodes and radio units.

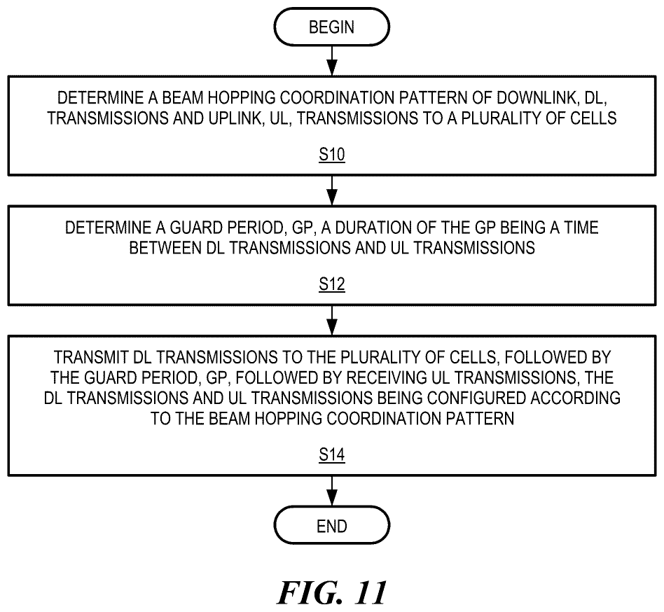

FIG. 11 is a flowchart of an example process in a network node 16 for low overhead NTN time division duplex operation. One or more blocks described herein may be performed by one or more elements of network node 16 such as by one or more of processing circuitry 36 (including the beam hopping unit 24), processor 38, and/or radio interface 30. Network node 16 such as via processing circuitry 36 and/or processor 38 and/or radio interface 30 is configured to determine a beam hopping coordination pattern of downlink, DL, transmissions and uplink, UL, receptions to a plurality of cells (Block S10). The process includes determining a guard period, GP, a duration of the GP being a time between DL transmissions and UL transmissions (Block S12). The process includes transmitting DL transmissions to the plurality of cells, followed by the guard period, GP, followed by receiving UL transmissions, the DL transmissions and UL transmissions being configured according to the beam hopping pattern (Block S14).

In some embodiments, the network node is a non-terrestrial satellite. In some embodiments, the beam hopping coordination pattern is configured to maximize a number of UEs served by the satellite for a given level of power consumption. In some embodiments, the GP is adaptively determined based at least in part on a time-varying distance between a satellite and a cell on the Earth. In some embodiments, the GP is adaptively determined based at least in part on a time-varying elevation angle. In some embodiments, a chronological order of the DL transmissions to the plurality of cells is one of statically and dynamically configured. In some embodiments, an order of the DL transmissions to the plurality of cells is UE-specific. In some embodiments, an order of the DL transmissions to the plurality of cells is selected to minimize the GP. In some embodiments, the GP is not less than twice maximum round trip time, RTT, observed across all cells of the plurality of cells. In some embodiments, the GP is not less than a sum of a first propagation delay associated with a last DL transmission to a first cell before transmission of the GP, and a second propagation delay associated with a first UL transmission after the GP. In some embodiments, a first UL transmission in a first cell is scheduled begin before expiration of the GP. In some embodiments, values of the adaptively determined GP are determinable in advance of GP transmission based at least in part on at least one of a step configuration, a mathematical formula and satellite ephemeris data. In some embodiments, the GP is a period between a DL transmission in a first cell of the plurality of cells and a subsequent UL transmission in a second cell of the plurality of cells, the first and second cells being non-adjacent and non-overlapping. In some embodiments, first DL transmissions are configured during a first active period of a first subset of satellite beams, and first UL transmissions are configured during a second active period of a second subset of beams, the second active period being subsequent to the first active period. In some embodiments, subsequent to the first UL transmissions, additional UL transmissions are configured during a third active period and DL transmissions are configured during a fourth active period, the fourth active period being subsequent to the third active period. In some embodiments, the first active period and the second active period are of unequal duration. In some embodiments, a duration of the first active period and of the second active period are selected adaptively based at least in part on a traffic distribution. In some embodiments, beams in each the first and second subsets are updated periodically. In some embodiments, the first and second active periods are included in a plurality of sequentially allocated active periods. In some embodiments, switching from DL transmissions to UL transmissions is configured to occur only between the first and active periods and switching from UL transmissions to DL transmissions is configured to occur during an active period for a subset of beams. In some embodiments, beams in a subset of beams are non-adjacent and non-overlapping. In some embodiments, beams in a subset of beams are separated in time. In some embodiments, the method further incudes scheduling communications with the UE based at least in part on a periodicity of active and inactive cells of the plurality of cells.

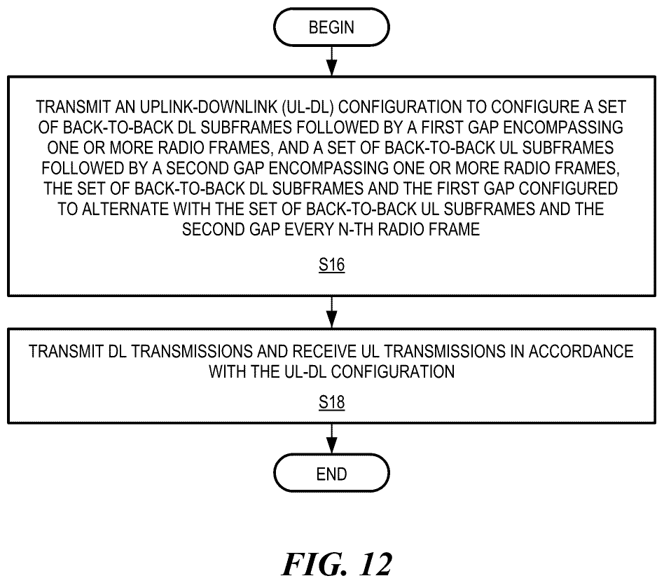

FIG. 12 is a flowchart of an example process in a network node 16, 26 for low overhead NTN time division duplex operation. One or more blocks described herein may be performed by one or more elements of network node 16, 26 such as by one or more of processing circuitry 36, 64 (including the beam hopping unit 24, 25), processor 38, and/or radio interface 30. Network node 16, 26 such as via processing circuitry 36, 64 and/or processor 38 and/or radio interface 30 is configured to transmit an uplink-downlink (UL-DL) configuration to configure a set of back-to-back DL subframes followed by a first gap encompassing one or more radio frames, and a set of back-to-back UL subframes followed by a second gap encompassing one or more radio frames, the set of back-to-back DL subframes and the first gap configured to alternate with the set of back-to-back UL subframes and the second gap every n-th radio frame (Block S16). The method also includes transmitting DL transmissions and receiving UL transmissions in accordance with the UL-DL configuration (Block S18).

In some embodiments, the first and second gaps include a guard period between DL transmissions to a plurality of cells and UL transmissions from the plurality of cells. In some embodiments, an order in which cells and UEs are configured for the DL and UL transmissions is determined to minimize the guard period between the DL transmissions and the uplink transmissions. In some embodiments, the UL-DL configuration is defined for a narrow band Internet of things (NB-IoT) frame structure. In some embodiments, the NB-IoT frame structure spans a plurality of radio frames.

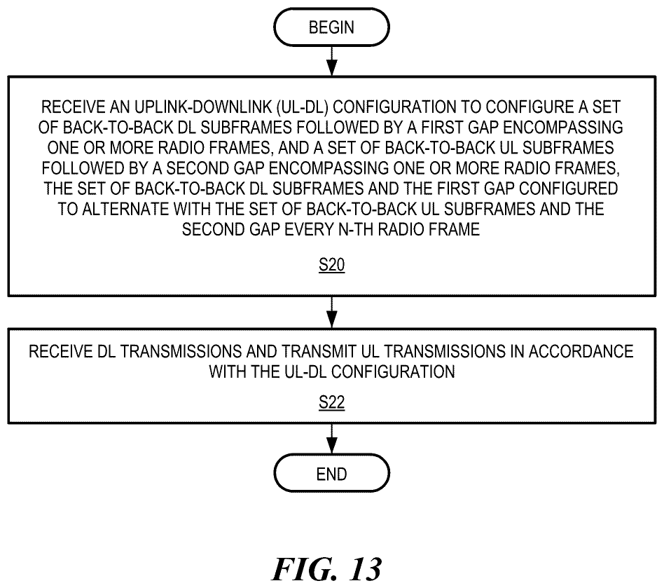

FIG. 13 is a flowchart of an example process in a UE 22 for low overhead NTN time division duplex operation. One or more blocks described herein may be performed by one or more elements of UE 22 such as by one or more of processing circuitry 50 (including the beam hopping unit 24), processor 52, and/or radio interface 46. The UE 22 such as via processing circuitry 50 and/or processor 52 and/or radio interface 46 is configured to receive an uplink-downlink (UL-DL) configuration to configure a set of back-to-back DL subframes followed by a first gap encompassing one or more radio frames, and a set of back-to-back UL subframes followed by a second gap encompassing one or more radio frames, the set of back-to-back DL subframes and the first gap configured to alternate with the set of back-to-back UL subframes and the second gap every n-th radio frame (Block S20). The method includes receiving DL transmissions and transmitting UL transmissions in accordance with the UL-DL configuration (Block S22).

In some embodiments, the first and second gaps include a guard period between DL transmissions to a plurality of cells and UL transmissions from the plurality of cells. In some embodiments, an order of cells for the DL transmissions and the UL transmissions across the plurality of cells is configured by radio resource control (RRC) signaling. In some embodiments, an order of UEs for the UL and DL transmissions is configured by radio resource control (RRC) signaling based at least in part on a priority. In some embodiments, an order in which cells and UEs are configured for the DL and UL transmissions is determined to minimize the guard period between the DL transmissions and the UL transmissions. In some embodiments, minimization of the guard period is based at least in part on scheduling DL and UL transmissions in a cell of the plurality of cells for which a propagation is delay is smallest before and after the guard period. In some embodiments, the guard period is at least as long as a sum of a propagation delay in a first cell of a last DL transmission before the guard period and a propagation delay in a second cell of a first UL transmission after the guard period. In some embodiments, the guard period is less than a sum of a propagation delay in a first cell of a last DL transmission before the guard period and a propagation delay in a second cell of a first UL transmission after the guard period. In some embodiments, the gap includes a guard period between UL transmissions and DL transmissions, the guard period being determined to be at least a maximum round trip time (RTT) across a plurality of cells served by a satellite.

In some embodiments, a duration of DL transmission is one of fixed and dynamically configured. In some embodiments, the UL-DL configuration is defined for a narrow band Internet of things (NB-IoT) frame structure. In some embodiments, the NB-IoT frame structure spans a plurality of radio frames.

Having described the general process flow of arrangements of the disclosure and having provided examples of hardware and software arrangements for implementing the processes and functions of the disclosure, the sections below provide details and examples of arrangements for low overhead NTN time division duplex operation.

### First Set of Embodiments: Basic Solution

In some embodiments, a time reuse pattern is introduced across a group of N cells to reduce inter-cell interference and increase the area coverage of a NTN node 26.

To minimize the DL-UL switching overhead, DL transmissions to all N cells in the group are performed, then a single DL-UL GP is followed by NUL transmissions from all cells in the group. In this approach, a single GP may be used, as compared to N GPs that would be needed in a conventional approach where in each of the N cells, a DL transmission would be followed by a GP and a UL transmission.

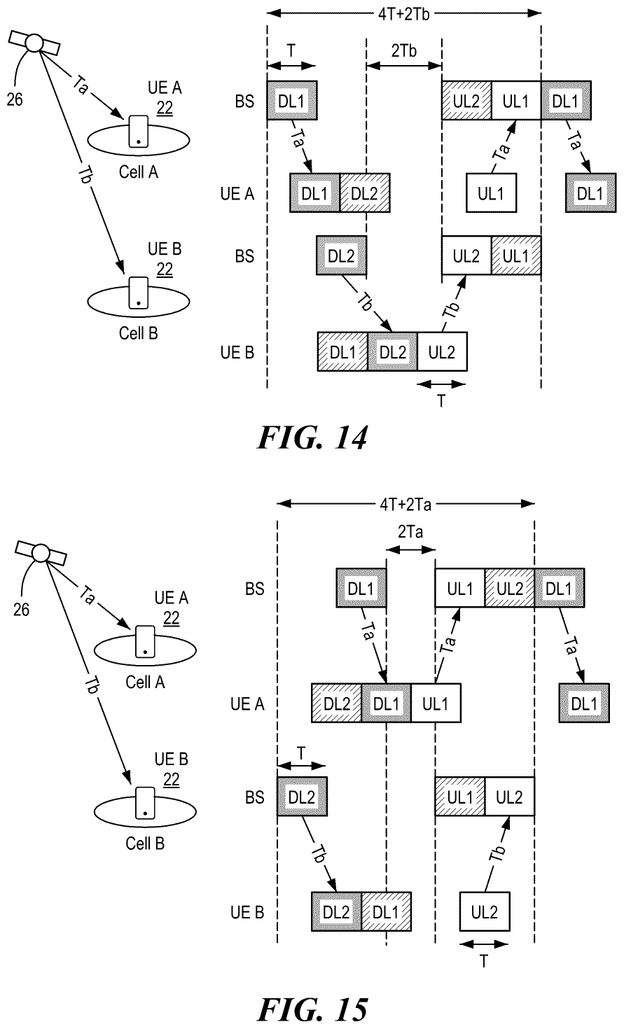

FIG. 14 shows two cells served by a single NTN node 26 with maximum propagation delays Ta and Tb, respectively. The DL and UL transmission are of length T and may include a configurable number of DL and UL slots or subframes, respectively.

### Second Set of Embodiments: Order of Transmissions

In some embodiments, the order in which transmissions across the N cells are determined on cell level, i.e., transmissions in cell A are followed by transmissions in cell B, and so on. This cell level transmission order may be statically configured by, for example, using radio resource control (RRC) signaling or dynamically, using radio link control (RLC), medium access control (MAC) or downlink control information (DCI)-based scheduling.

As an alternative to cell level, the DL/UL transmissions may be scheduled on the UE level. To exemplify: A transmission to UE A 22 in cell A may be followed by a transmission to UE B 22 in cell B, that is followed by a transmission to the same or different UE 22 in cell A. The order of transmission may be determined by a priority order, e.g., determined by the subscription priority or the application latency requirements of the of the different users. This is exemplified in FIG. 15, where the UL transmission of UE B 22 is of higher priority than the UL transmission of UE A 22, and UE B 22 is thus scheduled to transmit before UE A 22. The opposite situation where the UL transmission of UE A 22 is of higher priority than the UL transmission of UE B 22 is illustrated in FIG. 15.

The order in which cells or users are served may further be determined to minimize the GP. This may be achieved by scheduling transmission in the cell to which the propagation delay is the smallest before and after the GP. This is illustrated in FIG. 15.

### Third Set of Embodiments: Guard Period Dimensioning

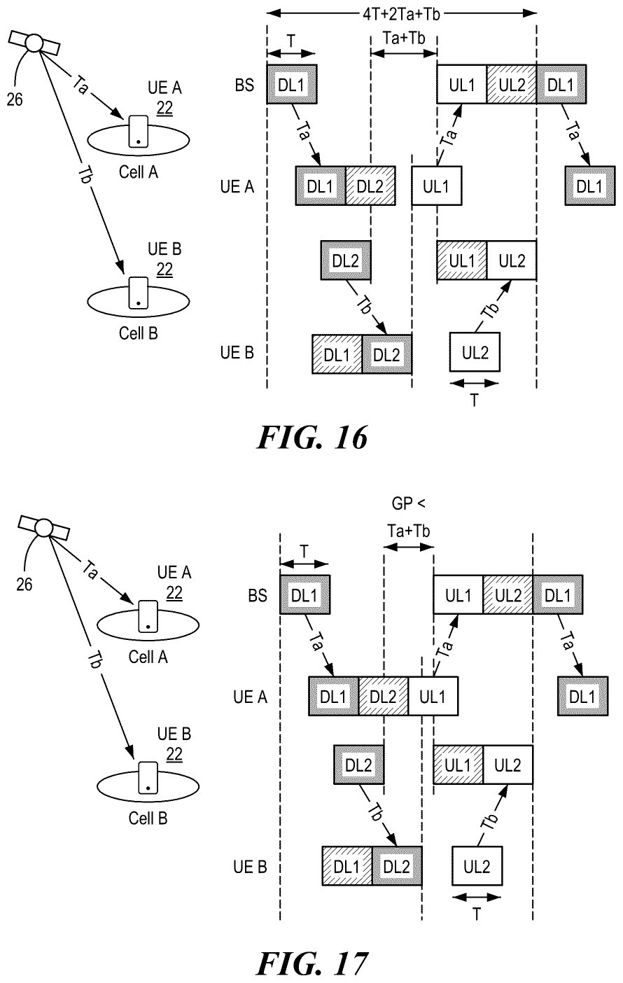

In some embodiments, the GP is dimensioned to at least twice the maximum RTT observed across all N cells served by a NTN node 26. This is exemplified in FIG. 16 where the GP is determined by propagation delay Tb that is larger than delay Ta. This may be compared to the conventional approach, where the GP is dimensioned according to the maximum RTT observed per cell.

Alternatively, the GP may be dimensioned to at least equal to the sum of (a) the propagation delay in the cell where the last DL transmission before the GP is performed and (b) the propagation delay in the cell where the first UL transmission after the GP is performed as illustrated in FIG. 17.

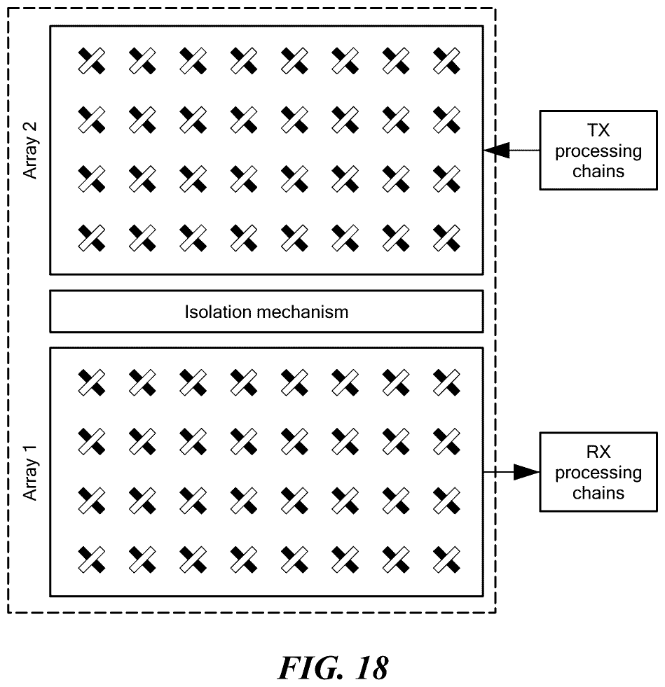

Alternatively, if the spatial isolation (e.g., due to a geographical large distance) between a pair of cells is significant, the GP may be reduced below the sum of (a) the propagation delay in the cell B where the last DL transmissions before the GP is performed and (b) the propagation delay in the cell A where the first UL transmissions after the GP is performed, by allowing an early transmission in cell A that transmits in the UL after the GP. This is illustrated in FIG. 18, where UE 22A in cell A starts its UL transmission before UE 22B in cell B has ended its DL reception.

In some embodiments, the GP is not static over time, but is changing over time according to the change in RTTs observed across all cells served by a NTN node 26 due to the motion of the NTN node 26 in its orbit. The RTT and the GP is dependent on the time varying elevation angle. The GP may be semi-statically configured, e.g., using RRC signaling or dynamically configured, using RLC, MAC or DCI based scheduling. Furthermore, as the satellite movements and thus, the change of RTTs, may be predictable, in some embodiments, the continuous (or step by step) change of the GP length may be signaled and/or configured in advance. For example, the continuous (or step by step) change of the GP length may be signaled a certain time period in advance. As another example, the change of GP length may be described as a mathematical formula, e.g., in relation to the ephemeris data of the serving NTN node 26, or as a table or series of GP length values (e.g. in the case of step by step changes of the GP length).

### Embodiments Leveraging Beam Hopping Time Gaps and Guard Distances to Eliminate the Need to Introduce Guard-Periods for the Purpose of Mitigating Interference Caused by TDD DL-UL and UL-DL Shifts

In some embodiments, the guard periods are completely removed, because gaps that inherently result from the deployment principle—if configured in a certain way—eliminate the need for additional guard periods for the purpose of avoiding interference problems in conjunction with DL/UL directional shifts in TDD. To this end, the concept of beam hopping considered for 3GPP Rel-19 of the 3GPP NR NTN standard may be utilized. With the beam hopping concept, a NTN node 26 is assumed to support multiple beams (also referred to as spotbeams), which may include potentially hundreds of beams (and where there may be a one-to-one or many-to-one relation between beams and cells). Only a subset of the beams are active at any one time, and the beams of the subset are changed on a time division basis, e.g., in a regular or irregular cycle, so that subsets of beams take turns in being active (and each beam gets its share of active time). A benefit of this is that a power-limited NTN node 26 may cover a large area with many beams, thus reducing the number of satellites the NTN operator has to launch. The hopping between beams, i.e., changing which beams are active, is coordinated among a set of beams, where such a coordinated set of beams may be served by a single NTN node 26 or multiple NTN nodes 26. The considered beam hopping scenarios include scenarios where the subset of simultaneously active beams is small compared to the total number of coordinated beams. This means that the duty cycle (the ratio of active time divided by the total time, i.e., the fraction of the time that a beam is active) is small.

In some embodiments, configurations may ensure that DL/UL shifts in a certain beam are done in the gaps between the active periods, and that beams potentially interfering with each other due to different DL/UL traffic directions are separated by a spatial guard distance, thereby ensuring that there is at least one (inactive) beam between them.

### Embodiments Considering TDD DL to UL Shifts (and Other Cross-Beam Interference)

In some embodiments, it is recognized that a guard period to mitigate the interference caused by TDD DL/UL shifts is needed only in shifts from DL to UL, but not for shifts from UL to DL.

Furthermore, in some embodiments, only UL transmissions or only DL transmissions are configured to occur in a certain active period of a subset of beams (and the other subsets are inactive). UL and DL transmissions may take turn every second time interval (where a time interval is the duration of an active period of a subset of beams) and the active periods are sequentially allocated to the beam subsets, i.e., if a subset of beams serve UL transmissions in one time interval, the subset of beams that is active in the subsequent time interval will serve DL transmissions in that active period, and the subset of beams active in the next time interval will serve UL transmissions in that time interval, etc. Note that a certain subset of beams will shift between DL and UL between successive active periods of that subset of beams). To avoid cross beam interference (regardless of TDD DL/UL shifts), a beam in a subset of beams should not be a neighbor to any other beam in the same subset of beams (counteracting the cross-beam interference caused by slow distance-based decrease of the signal strength). To avoid cross-beam interference caused by TDD DL to UL shifts, it should not be a neighbor to any beam in a subset of beams having an active period adjacent in time (if that beam subset in that active period has transmissions in the opposite direction such that a shift from DL to UL occurs at the border of the active periods). Thus, with beam hopping coordination fulfilling these principles, the harmful interference resulting from DL/UL shifts in TDD as well as from slow distance-dependent decrease of the signal strength may be mitigated and/or avoided, This method applies the built-in guard distances and guard periods resulting from the coordinated beam hopping, i.e., without introducing dedicated guard periods to cover the interference caused by the DL/UL shifts in TDD.

In one example, the subsets of beams in a coordinated set of beams may be numbered 1, 2, . . . N, N+1, N+2, . . . , M. Furthermore, the active periods and traffic directions of each subset of beams are assigned as follows in this example:
Time interval 1: Beam subset 1 is active (DL)
Time interval 2: Beam subset 2 is active (UL)
Time interval 3: Beam subset 3 is active (DL)
   :
   :
Time interval N−1: Beam subset N−1 is active (UL)
Time interval N: Beam subset N is active (DL)
Time interval N+1: Beam subset N+1 is active (UL)
   :
   :
Time interval M: Beam subset M is active (DL)

This may be a repetitive cycle so that beam subset 1 is active in time interval M+1, beam subset 2 is active in time interval M+2, etc., but with DL and UL shifted in each cycle. For example, beam subset 1 may serve UL traffic in time interval M+1, beam subset 2 may serve DL traffic in time interval M+2, etc. The number of beam subsets, M, may be chosen large enough to enable fulfilling the condition that a beam in beam subset N must not be a neighbor to any other beam in beam subset N, and that a beam in a subset of beams serving DL traffic in a time interval (e.g. time interval N) must not be a neighbor to any beam in the subset of beams that is active in the subsequent time interval (e.g. time interval N+1) if the traffic direction served in that subsequent time interval (or in the beginning of that subsequent time interval) is UL.

Shifting between DL and UL (or between UL and DL) at each time interval border may be performed in some embodiments disclosed herein. Consecutive time intervals with traffic in the same direction before shifting direction is also possible, and this may be either with the same beam subset being active in the consecutive time intervals or with different beam subsets being active in the different consecutive subsets.

In some embodiments, the time slot duration may be different for different time intervals. This may be semi-permanently configured or more dynamically configured by, for example, control signaling preceding each cycle or even preceding each time interval of the time slots. Such time interval duration variation may be used as a means to adapt to uneven DL/UL traffic distribution.

In some embodiments, another way to adapt to uneven DL/UL traffic distribution is to adapt the allocation of UL and DL traffic directions to time intervals to match the traffic distribution, e.g., letting more time intervals serve DL traffic than UL traffic or vice versa.

In some embodiments, the beams in different beam subsets may be dynamically changed, and/or the number of beam subsets may be changed dynamically. In other words, the beam subset constellations may in some embodiments be changed dynamically, either using semi-permanent configurations, or by more dynamic configuration signaling, e.g., per cycle.

In some embodiments, beams in a first beam subset may be neighbors to other beams in the same beam subset, but not to beams in a second beam subset with an active period adjacent in time, i.e., a beam subset having an active period in the time interval directly before or directly after the time interval in which the first beam subset has an active period, if a shift from DL to UL traffic occurs at that time interval border. Thus, in some embodiments the beam hopping configuration is adapted to avoid interference caused by TDD DL to UL shifts, but not to avoid other cross-beam interference.

In some embodiments, the TDD DL to UL shift-induced interference across beam borders is considered acceptable, but not other cross-beam interference. In these embodiments, TDD DL to UL shifts are avoided during a beam's active period (as disclosed above), and two beams being active at the same time may not be neighbors to each other (e.g., a beam in beam subset N may not be neighbor to another beam in beam subset N). However, beams in the first beam subset may be neighbors to beams in the second beam subset and/or a third beam subset, for example with active periods adjacent in time. For example, beam subsets may have active periods in the time intervals directly before and directly after the time interval in which the first beam subset has an active period (i.e., a beam in beam subset N may be neighbor to a beam(s) in beam subset N−1 and/or to beam(s) in beam subset N+1), regardless of TDD DL/UL shifts at the time interval borders.

In some embodiments, the beam hopping configuration does not avoid all cross-beam interference, but eliminates most interference-prone beam borders as disclosed above. But not all of them, allowing some beam neighbor relations between beams in a certain beam subset and other beams in the same beam subset, and/or allowing some beam neighbor relations between beams in different subsets of beams having active periods in adjacent time intervals, where a shift from DL to UL traffic occurs at the time interval border. This may be a trade-off to enable larger active duty cycles, i.e., enabling each beam to be active a larger fraction of the time.

As only shifts from DL to UL traffic (but not shifts from UL to DL traffic) cause harmful interference, the solution may be made more flexible by not precluding shifts from UL to DL traffic during (e.g., in the middle of) an active period (i.e., during or in the middle of a time interval). Shifts from DL to UL traffic would thus only occur at time interval borders, but shifts from UL to DL traffic may occur during or in the middle of a time interval. This may be combined with any of the embodiments disclosed above.

### Embodiments Considering all TDD Traffic Direction Shifts (and Other Cross-Beam Interference)

In some embodiments, the neighbor relation principles are extended to consider also neighbor relations at time interval borders where TDD UL to DL shifts occur. This may simplify the division of beams into different beam subsets, as the neighbor relations will follow the same principles, and may remain the same in subsequent cycles where the per beam subset TDD traffic direction per time interval is shifted between the cycles.

In some embodiments, only UL transmissions or only DL transmissions are configured to occur in a certain active period of a subset of beams (and the other beam subsets are inactive). UL and DL transmissions may take turn every second time interval (where a time interval is the duration of an active period of a subset of beams) and the active periods are sequentially allocated to the beam subsets. In other words, if a subset of beams serve UL transmissions in one time interval, the subset of beams that is active in the subsequent time interval will serve DL transmissions in that active period, and the subset of beams active in the next time interval will serve UL transmissions in that time interval, etc. Note that a certain subset of beams will shift between UL and DL (or vice versa) between successive active periods of that subset of beams. To avoid cross beam interference (regardless of TDD DL/UL shifts), a beam in a subset should not be a neighbor to any other beam in the same subset (counteracting the cross-beam interference caused by slow distance-based decrease of the signal strength). A Iso, to avoid cross-beam interference caused by TDD DL/UL shifts, the beam in the subset should not be a neighbor to any beam in a subset of beams having an active period adjacent in time (if that beam subset in that active period has transmissions in the opposite direction). Thus, with a beam hopping coordination fulfilling these principles, the harmful interference resulting from DL/UL shifts in TDD as well as from slow distance-dependent decrease of the signal strength may be mitigated and/or avoided. This employs the built-in guard distances and guard periods resulting from the coordinated beam hopping, i.e., without introducing dedicated guard periods to cover the interference caused by the DL/UL shifts in TDD.

In an illustrative example, the subsets of beams in a coordinated set of beams are numbered 1, 2, . . . N, N+1, N+2, . . . , M. Furthermore, the active periods and traffic directions of each subset of beams are assigned as follows in this example:
Time interval 1: Beam subset 1 is active (DL)
Time interval 2: Beam subset 2 is active (UL)
Time interval 3: Beam subset 3 is active (DL)
   :
   :
Time interval N−1: Beam subset N−1 is active (UL)
Time interval N: Beam subset N is active (DL)
Time interval N+1: Beam subset N+1 is active (UL)
   :
   :
Time interval M: Beam subset M is active (DL)

This may be a repetitive cycle so that beam subset 1 is active in time interval M+1, beam subset 2 is active in time interval M+2, etc., but with DL and UL shifted in each cycle (i.e. beam subset 1 serves UL traffic in time interval M+1, beam subset 2 serves DL traffic in time interval M+2, etc.). The number of beam subsets, M, may be chosen large enough to enable fulfilment of the condition that a beam in beam subset N must neither be a neighbor to any other beam in beam subset N nor to any beam in beam subsets N−1 and N+1.

Shifting between DL and UL (or between UL and DL) at each time interval border may be employed in some embodiments. Consecutive time intervals with traffic in the same direction before shifting direction is also possible, and this may be either with the same beam subset being active in the consecutive time intervals or with different beam subsets being active in the different consecutive subsets.

In some embodiments, the time slot duration may be different for different time intervals. This may be semi-permanently configured or more dynamically configured, e.g., using control signaling preceding each cycle or even preceding each time interval of the time slots. Such time interval duration variation may be used as a means to adapt to uneven DL/UL traffic distribution.

In some embodiments, another way to adapt to uneven DL/UL traffic distribution is to adapt the allocation of UL and DL traffic directions to time intervals to match the traffic distribution, for example, by letting more time intervals serve DL traffic than UL traffic or vice versa.

In some embodiments, the beams in different beam subsets may be dynamically changed, and/or the number of beam subsets may be changed dynamically. In other words, the beam subset constellations may be changed dynamically, either using semi-permanent configuration, or more dynamic configuration signaling, e.g., per cycle.

In some embodiments, beams in a first beam subset may be neighbors to other beams in the same beam subset, but not to beams in other beam subsets with active periods adjacent in time. The other beam subsets may have active periods in the time intervals directly before and directly after the time interval in which the first beam subset has an active period (e.g. beam subsets N−1 and N+1). That is, in these embodiments, the beam hopping configuration is adapted to avoid interference caused by TDD DL/UL shifts, but not to avoid other cross-beam interference.

In some embodiments, the TDD DL/UL shift-induced interference across beam borders is considered acceptable, but not other cross-beam interference. In these embodiments, TDD DL/UL shifts are avoided during a beam's active period (as disclosed above), and two beams being active at the same time may not be neighbors to each other. For example, a beam in beam subset N may not be neighbor to another beam in beam subset N. However, beams in a first beam subset may be neighbors to beams in other beam subsets with active periods adjacent in time. That is, beam subsets having active periods in the time intervals directly before and directly after the time interval in which the first beam subset has an active period. In other words, a beam in beam subset N may be neighbor to a beam(s) in beam subset N−1 and/or to beam(s) in beam subset N+1.

In some embodiments, beams in beam subset N may have neighbor relations to beams in subset N−1, but not to beams in beam subsets N and N+1.

In some embodiments, beams in beam subset N may have neighbor relations to beams in subsets N and N−1, but not to beams in beam subsets N+1.

In some embodiments, beams in beam subset N may have neighbor relations to beams in subset N+1, but not to beams in beam subsets N and N−1

In some embodiments, beams in beam subset N may have neighbor relations to beams in subsets N and N+1, but not to beams in beam subsets N−1.

In some embodiments, the beam hopping configuration does not avoid all cross-beam interference, e.g., eliminating most interference-prone beam borders, as disclosed above, but not all of them. For example, some beam neighbor relations between beams in beam subset N and beams in beam subsets N−1 and/or N+1 and/or N, be allowed. This may be a trade-off to enable larger active duty cycles, i.e., enabling each beam to be active a larger fraction of the time.

In some embodiments, different beams in the same beam subset may serve traffic in different directions in the same active period (active time interval). For example, one subset of beams of the beam subset may serve UL traffic, while the remainder of the beams in the beam subset serve DL traffic. As an example, assume a beam subset consisting of 10 beams numbered [1 . . . 10]. Then, in one active period, beams 1-5 may serve UL traffic while beams 6-10 serve DL traffic. And in the next active period of that beam subset, the traffic directions are swapped, i.e., beams 1-5 serve DL traffic and beams 6-10 serve UL traffic. In some embodiments, the number of beams serving UL traffic may be different from the number of beams serving DL traffic in the same active period. In some embodiments, this division of number beams serving the different traffic directions in the same active period in a certain beam subset may vary between different active periods of the beam subset. In some embodiments, the traffic direction served by a certain beam may not shift for each new active period. In other words, the served traffic direction for a certain beam may remain the same for more than one consecutive active period.

Embodiments Considering Simultaneous DL and UL Traffic in Separate Cells with Sufficient Spatial Separation

In some embodiments, in a certain active period, DL transmissions are configured to occur in one subset of beams simultaneously with UL transmissions in one or more other subsets of beams (and the other subsets are inactive). A power-limited NTN node 26 may transmit continuously without interruptions for UL transmission, thereby maximizing the number of cells it may serve. Some embodiments are useful when the power limitation of the NTN node 26 necessitates beam hopping with a low duty cycle.

The term “spatial separation” may refer to spatial separation of beam footprints (i.e., beam directions). In this case, one example of “sufficient spatial separation” is beams that are not neighbors. Spatial separation may also refer to spatial separation of antennas (e.g., separate transmit (TX) and receive (RX) antennas with sufficient spatial separation). This is shown in FIG. 18. It may also refer to a combination of both spatial separation of beam footprints and antennas.

To avoid cross beam BS transmit (TX) to UE receive (RX) and UE TX to BS RX interference between beams in the same subset (regardless of TDD DL/UL shifts), a beam in a subset of beams should have sufficient spatial separation to any other beam in the same subset of beams (counteracting the cross-beam interference caused by slow distance-based decrease of the signal strength). In this case, spatial separation refers to spatial separation of beam footprints.

To avoid cross-beam UE TX to UE RX interference caused by TDD DL to UL shifts between beams in different subsets, a beam in a subset of beams should have sufficient spatial separation to any beam in a subset of beams having an active period adjacent in time, if that beam subset in that active period has transmissions in the opposite direction such that a shift from DL to UL occurs at the border of the active periods. In this case, spatial separation refers to spatial separation of beam footprints.

To avoid cross-beam UE TX to UE RX and BS TX to BS RX interference caused by simultaneous DL and UL transmission, a beam in a subset of beams for DL transmission should have sufficient spatial separation to any beam in a subset of beams for UL transmission in the same active period. In this case, spatial separation refers to spatial separation of beam footprints to avoid UE TX to UE RX interference and spatial separation of antennas and/or beam footprints to avoid BS TX to BS RX interference.

Thus, with beam hopping coordination as disclosed herein, the harmful interference resulting from DL/UL shifts in TDD, simultaneous DL and UL transmission in beams with insufficient spatial separation, as well as from slow distance-dependent decrease of the signal strength may be mitigated and/or avoided, thereby utilizing the built-in guard distances and guard periods resulting from the coordinated beam hopping. This avoids introducing dedicated guard periods to cover the interference caused by the DL/UL shifts in TDD.

In an illustrative example, the subsets of beams in a coordinated set of beams are numbered 1, 2, . . . N, N+1, N+2, . . . , M. Furthermore, the active periods and traffic directions of each subset of beams are assigned as follows in this example:
Time interval 1: Beam subset 1 is active in DL, beam subset u(1) is active in UL
Time interval 2: Beam subset 2 is active in DL, beam subset u(2) is active in UL
Time interval 3: Beam subset 3 is active in DL, beam subset u(3) is active in UL
   :
   :
Time interval N−1: Beam subset N−1 is active in DL, beam subset u(N−1) is active in UL
Time interval N: Beam subset N is active in DL, beam subset u(N) is active in UL
Time interval N+1: Beam subset N+1 is active in DL, beam subset u(N+1) is active in UL
   :
   :
Time interval M: Beam subset M is active in DL and beam subset u(M) is active in UL
   where u(1 . . . M) is some sequence of UL beam subsets fulfilling the restrictions defined above.

This may be a repetitive cycle so that beam subset 1 is active in time interval M+1, beam subset 2 is active in time interval M+2, etc.

The number of beam subsets, M, may be chosen large enough to enable fulfilment of the condition that a beam in beam subset N must have sufficient spatial separation to any other beam in beam subset N. A beam in a subset of beams serving DL traffic in a time interval (e.g., time interval N) should have sufficient spatial separation to any beam in the subset of beams that is active in the subsequent time interval, N+1, if the traffic direction served in that beam in the subsequent time interval (or in the beginning of that subsequent time interval) is UL. A beam in a subset of beams serving DL traffic in time interval N should have sufficient spatial separation to any beam in the subset of beams for UL transmission that is active in the same time interval.

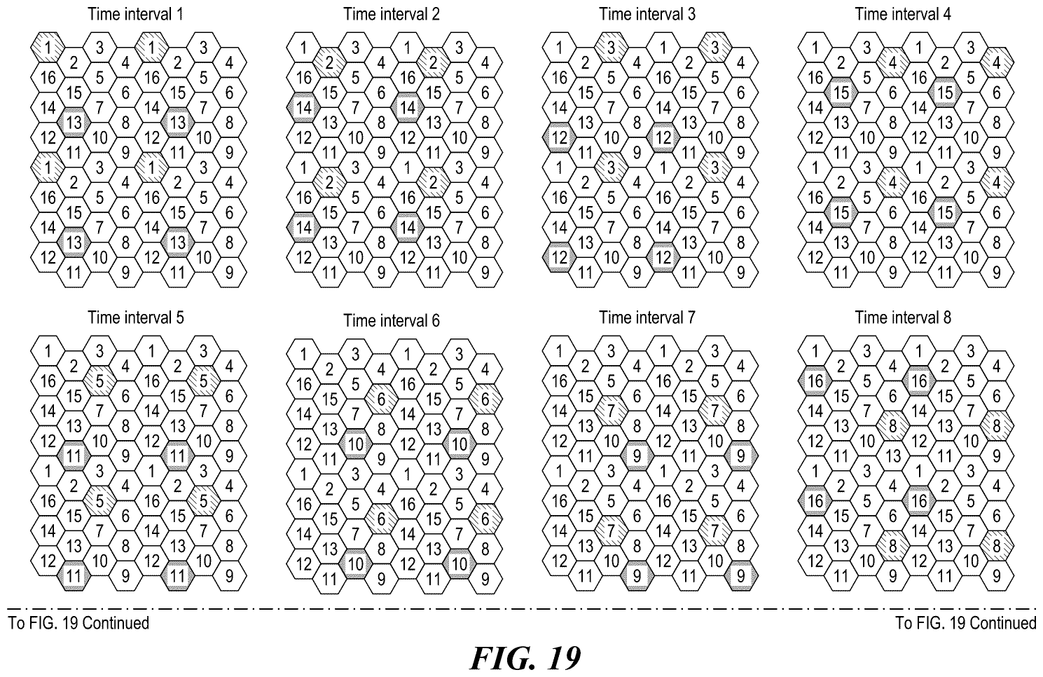

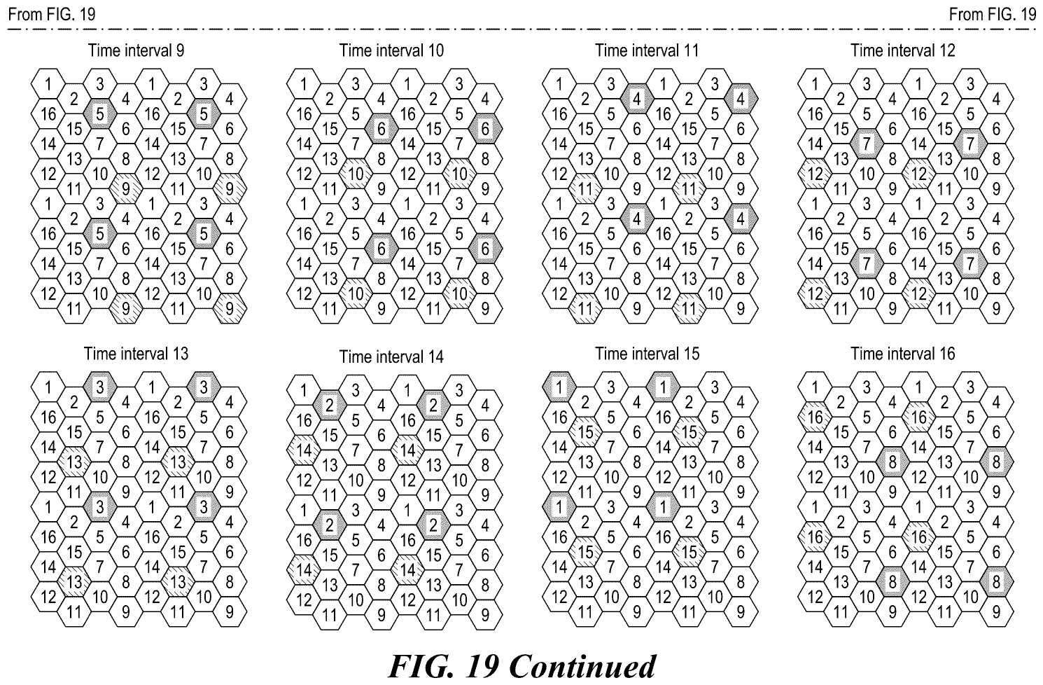

An example is shown in FIG. 19. In this example, there are 64 beams divided into 16 subsets of 4 beams each. The number in each beam indicates to which subset the beam belongs. The length of the beam subset hopping sequence is M=16, the sequence of DL beam subsets is [1 2 3 4 5 6 7 8 9 10 11 12 13 14 15 16] and the sequence of UL beam subsets is u=[13 14 12 15 11 10 9 16 5 6 4 7 3 2 1 8]. In this example, it is assumed that “sufficient spatial separation” is achieved if the beams are not neighbors.

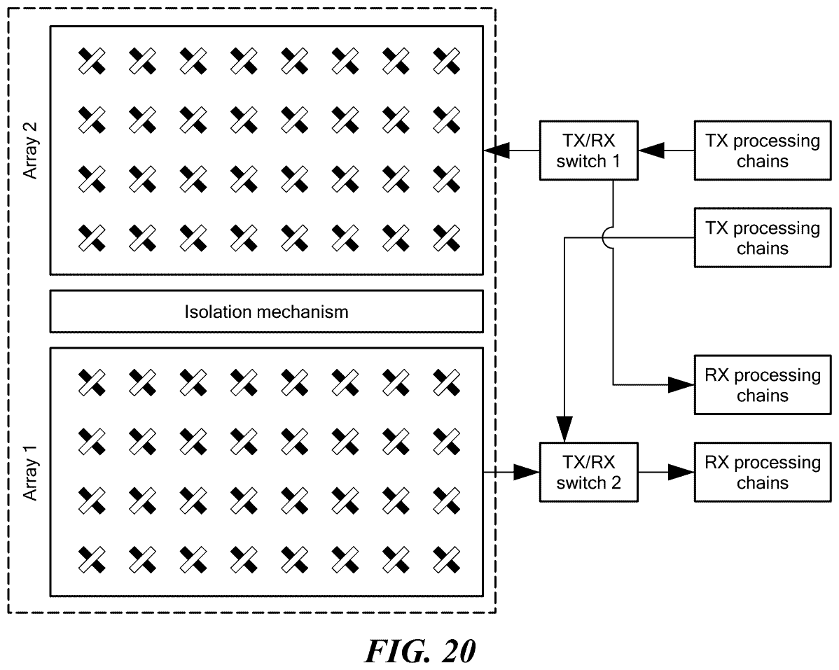

In some embodiments, as shown in FIG. 20, antenna arrays may be dynamically switched between TX and RX processing chains subject to the traffic demands across cells. For example, there may be a balanced number of cells serving the DL traffic and UL traffic, all cells serving DL traffic, or all cells serving UL traffic. The traffic demands across cells under the satellite footprint may be such that a balanced number of cells serving the DL traffic and UL traffic, Array l and Array 2 are respectively mapped to RX and TX processing chains. In another situation, with all cells serving the DL traffic, Array 1 and/or Array 2 may be mapped to the TX processing chains at the NTN node 26. Alternatively, if all the cells are associated with the UL traffic at a particular instant, then Array 1 and/or Array 2 may be mapped to the RX processing chains at the NTN node 26.

### Embodiments for Adapting the TDD NB-IoT Framework for a TDD Operation in IoT-NTN

In some embodiments, in a non-terrestrial satellite communication network based at least in part on an Internet of things (IoT) radio access technology (e.g., NB-IoT) using a frame structure type 2, the eNodeB scheduler may instruct a given NTN node 26 to serve in downlink (i.e., transmit one or more downlink physical channel(s) and/or signal(s)) one cell at a time among a plurality of cells within the satellite's footprint. Then, after a gap serving in uplink one or more uplink physical channel(s) and/or signal(s) may be transmitted one cell at a time among a plurality of cells within the satellite's footprint.

In some embodiments, one or more of the uplink-downlink configurations 1, 2, 3, 4, 5 defined for frame structure type 2 in TDD-NB-IoT are fully or partially re-used to incorporate a TDD operation for IoT-N T N, where the gap is redefined to account for the RTT experienced in an NTN communication.

In some embodiments, one or more new uplink-downlink configurations may be defined for frame structure type 2 in TDD-NB-IoT for NTN. For example, a new uplink-downlink configuration with a dual-interpretation may be defined, which in a first time instance may consist of 9 back-to-back DL subframes followed by a special subframe which is used to introduce a gap. Then, after the gap, which may encompass one or more radio frames, the same configuration may be interpreted to consists of 9 UL subframes followed by a special subframe which is used to introduce a gap. Afterwards, the dual-interpretation starts over.

| Uplink- | Downlink- | | | | | | | | | | |
|---|---|---|---|---|---|---|---|---|---|---|---|
| downlink | to-Uplink | | | | | | | | | | |
| configu- | Switch-point | Subframe number | | | | | | | | | |
| ration | periodicity | 0 | 1 | 2 | 3 | 4 | 5 | 6 | 7 | 8 | 9 |
| 7a | n(10 ms) | D | D | D | D | D | D | D | D | D | S |
| 7b | | U | U | U | U | U | U | U | U | U | S |

Where n is an integer number and depends e.g., on the RTT.
Note:
D stands for downlink subframe
U stands for uplink subframe
S stands for special subframe

In some embodiments, one or more new uplink-downlink configurations are defined for frame structure type 2 in TDD-NB-IoT for NTN, where one or more of the new uplink-downlink configurations may have a dual-interpretation. The dual interpretation may depend on whether the radio frame in turn is an even radio frame or an odd radio frame. For example, in an even radio frame, a given uplink-downlink configuration may act as having a set of back-to-back downlink subframes followed by a special subframe (which includes a gap), whereas at the nth odd radio frame after the gap, the same uplink-downlink configuration may act as having a set of back-to-back uplink subframes followed by a special subframe (which includes a gap).

In some embodiments, one or more new uplink-downlink configurations may be defined for frame structure type 2 in TDD-NB-IoT for NTN, which may span more than one radio frame. For example, a subframe number may span from 0 to 19 to encompass two radio frames, or the subframe number may span from 0 to 29 to encompass three radio frames, and so on.

In some embodiments, the one or more new uplink-downlink configurations defined for frame structure type 2 in TDD-NB-IoT for NTN, may span more than one radio frame includes a set of back-to-back DL subframes, a special subframe (including a gap), and a set of back-to-back UL subframes.

In some embodiments, the one or more new uplink-downlink configurations defined for frame structure type 2 in TDD-NB-IoT for NTN may be used along with hybrid automatic repeat request (HARQ) disabled. This facilitates having a set of back-to-back DL subframes followed by a special subframe (including a gap), and a set of back-to-back UL subframes.

In some embodiments, one or more of the narrowband physical random access channel (NPRACH) formats and random-access preamble parameters including frequency hopping defined for frame structure type 2 are fully or partially re-used to incorporate a TDD operation for IoT-NTN.

In some embodiments, where there are enough UL subframes back-to-back, one or more of the NPRACH formats and random-access preamble parameters including frequency hopping defined for frame structure type 1 are fully or partially re-used to incorporate a TDD operation for IoT-NTN.

In some embodiments, a narrowband physical uplink shared channel (NPUSCH) with 15 kHz subcarrier spacing having a slot duration of 0.5 ms is supported. When there are enough UL subframes back-to-back, then an NPUSCH with 3.75 kHz subcarrier spacing having a slot duration of 2 ms may also be supported in a TDD operation for IoT-NTN.

In some embodiments, TDD-NB-IoT for NTN may introduce one or more collision rules as to prioritize downlink over uplink, or uplink over downlink. For example, one collision rule may be defined for the UE 22 to prioritize the reception of a given physical downlink channel or signal over an uplink transmission, in which case the uplink transmission is dropped.

In some embodiments, anchor and/or non-anchor carriers may be employed.

Some embodiments may be used for one or more of the NB-IoT deployment modes (Stand-alone operation, guard band operation, and in-band operation).

Some embodiments may be used in an NTN deployment using “one beam per cell”.

Some embodiments may be used in an NTN deployment using “more than one beam per cell”.

Some embodiments may be equally applicable to a non-terrestrial network scenario based at least in part on transparent payload or regenerative payload.

Some embodiments may be equally applicable to different satellite orbits such as LEO, MEO, and GEO.

Some embodiments may include one or more of the following:

Example A1. A network node configured to communicate with a user equipment (UE), the network node configured to, and/or comprising a radio interface and/or comprising processing circuitry configured to:
determine a beam hopping coordination pattern of downlink, DL, transmissions and uplink, UL, receptions to a plurality of cells;
determine a guard period, GP, a duration of the GP being a time between DL transmissions and UL transmissions; and
transmit DL transmissions to the plurality of cells, followed by the guard period, GP, followed by receiving UL transmissions, the DL transmissions and UL transmissions being configured according to the beam hopping coordination pattern.

Example A2. The network node of Example A1, wherein the network node, radio interface and/or processing circuitry are configured in a non-terrestrial satellite.

Example A3. The network node of Example A2, wherein the beam hopping coordination pattern is configured to maximize a number of UEs served by the satellite for a given level of power consumption.

Example A4. The network node of any of Examples A2 and A3, wherein the GP is adaptively determined based at least in part on a time-varying distance between the satellite and one or more cells on the Earth.

Example A5. The network node of any of Examples A1-A3, wherein the GP is adaptively determined based at least in part on a time-varying elevation angle.

Example A6. The network node of any of Examples A1-A4, wherein a chronological order of the DL transmissions to the plurality of cells is one of statically and dynamically configured.

Example A7. The network node of any of Examples A1-A6, wherein an order of the DL transmissions and UL transmissions to the plurality of cells is selected to minimize the GP.

Example A8. The network node of any of Examples A1-A7, wherein the GP is not less than twice maximum round trip time, RTT, observed across all cells of the plurality of cells.

Example A9. The network node of any of Examples A1-A8, wherein the GP is not less than a sum of a first propagation delay associated with a last DL transmission to a first cell before transmission of the GP, and a second propagation delay associated with a first UL transmission after the GP.

Example A10. The network node of any of Examples A1-A9, wherein a first UL transmission in a first cell is scheduled begin before expiration of the GP.

Example A11. The network node of any of Examples A1-A10, wherein multiple values of the GP are determinable in advance of DL transmissions based at least in part on at least one of a step configuration, a mathematical formula and satellite ephemeris data.

Example A12. The network node of any of Example A1-A11, wherein the GP is a period between a DL transmission in a first cell of the plurality of cells and a subsequent UL transmission in a second cell of the plurality of cells, the first and second cells being non-adjacent and non-overlapping.

Example A13. The network node of any of Examples A1-A12, wherein first DL transmissions are configured during a first active period of a first subset of satellite beams, and first UL transmissions are configured during a second active period of a second subset of beams, the second active period being subsequent to the first active period.

Example A14. The network node of Example A13, wherein, subsequent to the first UL transmissions, additional UL transmissions are configured during a third active period and DL transmissions are configured during a fourth active period, the fourth active period being subsequent to the third active period.

Example A15. The network node of any of Examples A13 and A14, wherein the first active period and the second active period are of unequal duration.

Example A16. The network node of any of Examples A13-A15, wherein a duration of the first active period and of the second active period are selected adaptively based at least in part on a traffic distribution.

Example A17. The network node of any of Examples A13-A16, wherein beams in each the first and second subsets are updated periodically.

Example A18. The network node of any of Examples A13-A17, wherein the first and second active periods are included in a plurality of sequentially allocated active periods.

Example A19. The network node of any of Examples A13-A18, wherein switching from DL transmissions to UL transmissions is configured to occur only between the first and active periods and switching from UL transmissions to DL transmissions is configured to occur during an active period for a subset of beams.

Example A20. The network node of any of Examples A13-A19, wherein beams in a subset of beams are non-adjacent and non-overlapping.

Example A21. The network node of Example A13-A20, wherein beams in a subset of beams are separated in time.

Example A22. The network node of any of Examples A1-A21, wherein the network node, radio interface and/or processing circuitry are configured to schedule communications with the UE based at least in part on a periodicity of active and inactive cells of the plurality of cells.

Example B1. A method in a network node configured to communicate with a user equipment (UE), the method comprising:
determining a beam hopping coordination pattern of downlink, DL, transmissions and uplink, UL, receptions to a plurality of cells;
determining a guard period, GP, a duration of the GP being a time between DL transmissions and UL transmissions; and
transmitting DL transmissions to the plurality of cells, followed by the guard period, GP, followed by receiving UL transmissions, the DL transmissions and UL transmissions being configured according to the beam hopping pattern.

Example B2. The method of Example B1, wherein the network node is a non-terrestrial satellite.

Example B3. The method of Example B2, wherein the beam hopping coordination pattern is configured to maximize a number of UEs served by the satellite for a given level of power consumption.

Example B4. The method of any of Examples B2 and B3, wherein the GP is adaptively determined based at least in part on a time-varying distance between the satellite and a cell on the Earth.

Example B5. The method of any of Examples B1-B4, wherein the GP is adaptively determined based at least in part on a time-varying elevation angle.

Example B6. The method of any of Examples B1-B5, wherein a chronological order of the DL transmissions to the plurality of cells is one of statically and dynamically configured.

Example B7. The method of any of Examples B1-B6, wherein an order of the DL transmissions to the plurality of cells is selected to minimize the GP.

Example B8. The method of any of Examples B1-B7, wherein the GP is not less than twice maximum round trip time, RTT, observed across all cells of the plurality of cells.

Example B9. The method of any of Examples B1-B8, wherein the GP is not less than a sum of a first propagation delay associated with a last DL transmission to a first cell before transmission of the GP, and a second propagation delay associated with a first UL transmission after the GP.

Example B10. The method of any of Examples B1-B9, wherein a first UL transmission in a first cell is scheduled begin before expiration of the GP.

Example B11. The method of any of Examples B1-B10, wherein multiple values of the GP are determinable in advance of DL transmissions based at least in part on at least one of a step configuration, a mathematical formula and satellite ephemeris data.

Example B12. The method of any of Example B1-B11, wherein the GP is a period between a DL transmission in a first cell of the plurality of cells and a subsequent UL transmission in a second cell of the plurality of cells, the first and second cells being non-adjacent and non-overlapping.

Example B13. The method of any of Examples B1-B12, wherein first DL transmissions are configured during a first active period of a first subset of satellite beams, and first UL transmissions are configured during a second active period of a second subset of beams, the second active period being subsequent to the first active period.

Example B14. The method of Example B13, wherein, subsequent to the first UL transmissions, additional UL transmissions are configured during a third active period and DL transmissions are configured during a fourth active period, the fourth active period being subsequent to the third active period.

Example B15. The method of any of Examples B13 and B14, wherein the first active period and the second active period are of unequal duration.

Example B16. The method of any of Examples B13-B15, wherein a duration of the first active period and of the second active period are selected adaptively based at least in part on a traffic distribution.

Example B17. The method of any of Examples B13-B16, wherein beams in each the first and second subsets are updated periodically.

Example B18. The method of any of Examples B13-B17, wherein the first and second active periods are included in a plurality of sequentially allocated active periods.

Example B19. The method of any of Examples B13-B18, wherein switching from DL transmissions to UL transmissions is configured to occur only between the first and active periods and switching from UL transmissions to DL transmissions is configured to occur during an active period for a subset of beams.

Example B20. The method of any of Examples B13-B19, wherein beams in a subset of beams are non-adjacent and non-overlapping.

Example B21. The method of Example B13-B20, wherein beams in a subset of beams are separated in time.

Example B22. The method of any of Examples B1-B21, further comprising scheduling communications with the UE based at least in part on a periodicity of active and inactive cells of the plurality of cells.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROM s, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviation | Explanation |
|---|---|
| DL | Downlink |
| GP | Gap |
| NB-IoT | Narrowband-Internet of Things |
| NPRACH | Narrowband Physical Random-Access Channel |
| NPUSCH | Narrowband Physical Uplink Shared Channel |
| NTN | Non-Terrestrial Networks |
| Rx | Receiver |
| TDD | Time Division Duplex |
| TN | Terrestrial Networks |
| Tx | Transmitter |
| UL | Uplink |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

What is claimed is:

1. A method performed by a user equipment (UE) served by a satellite based network node in a non-terrestrial satellite communication network for a radio access technology using time division duplex, the method comprising:
receiving an uplink-downlink (UL-DL) configuration to configure a set of back-to-back DL subframes followed by a first gap encompassing one or more radio frames, and a set of back-to-back UL subframes followed by a second gap encompassing one or more radio frames, the set of back-to-back DL subframes and the first gap configured to alternate with the set of back-to-back UL subframes and the second gap every n-th radio frame; and
receiving DL transmissions and transmitting UL transmissions in accordance with the UL-DL configuration.

2. The method of claim 1, wherein the first and second gaps include a guard period between DL transmissions to a plurality of cells and UL transmissions from the plurality of cells.

3. The method of claim 2, wherein an order of cells for the DL transmissions and the UL transmissions across the plurality of cells is configured by radio resource control (RRC) signaling.

4. The method of claim 2, wherein an order of UEs for the UL and DL transmissions is configured by radio resource control (RRC) signaling based at least in part on a priority.

5. The method of claim 2, wherein an order in which cells and UEs (22) are configured for the DL and UL transmissions is determined to minimize the guard period between the DL transmissions and the UL transmissions.

6. The method of claim 5, wherein minimization of the guard period is based at least in part on scheduling DL and UL transmissions in a cell of the plurality of cells for which a propagation is delay is smallest before and after the guard period.

7. The method of claim 2, wherein the guard period is at least as long as a sum of a propagation delay in a first cell of a last DL transmission before the guard period and a propagation delay in a second cell of a first UL transmission after the guard period.

8. The method of claim 2, wherein the guard period is less than a sum of a propagation delay in a first cell of a last DL transmission before the guard period and a propagation delay in a second cell of a first UL transmission after the guard period.

9. The method of claim 1, wherein the gap includes a guard period between UL transmissions and DL transmissions, the guard period being determined to be at least a maximum round trip time (RTT) across a plurality of cells served by a satellite.

10. The method of claim 1, wherein a duration of DL transmission is one of fixed and dynamically configured.

11. The method of claim 1, wherein the UL-DL configuration is defined for a narrow band Internet of things (NB-IoT) frame structure.

12. A user equipment (UE) served by a satellite based network node in a non-terrestrial satellite communication network for a radio access technology using time division duplex, the UE comprising processing circuitry configured to:
receive an uplink-downlink (UL-DL) configuration to configure a set of back-to-back DL subframes followed by a first gap encompassing one or more radio frames, and a set of back-to-back UL subframes followed by a second gap encompassing one or more radio frames, the set of back-to-back DL subframes and the first gap configured to alternate with the set of back-to-back UL subframes and the second gap every n-th radio frame; and
receive DL transmissions and transmit UL transmissions in accordance with the UL-DL configuration.

13. The UE of claim 12, wherein the first and second gaps include a guard period between DL transmissions to a plurality of cells and UL transmissions for the plurality of cells.

14. The UE of claim 13, wherein an order of cells for the DL transmissions and the UL transmissions across the plurality of cells is configured by radio resource control (RRC) signaling.

15. The UE of claim 13, wherein an order of UEs for the UL and DL transmissions is configured by radio resource control (RRC) signaling based at least in part on a priority.

16. The UE of claim 13, wherein an order in which cells and UEs (22) are configured for the UL and DL transmissions is determined to minimize the guard period between the DL transmissions and the UL transmissions.

17. The UE of claim 16, wherein minimization of the guard period is based at least in part on scheduling DL and UL transmissions in a cell of the plurality of cells for which a propagation is delay is smallest before and after the guard period.

18. The UE of claim 13, wherein the guard period is at least as long as a sum of a propagation delay in a first cell of a last DL transmission before the guard period and a propagation delay in a second cell of a first UL transmission after the guard period.

19. The UE of claim 13, wherein the guard period is less than a sum of a propagation a delay in a first cell of a last DL transmission before the guard period and a propagation delay in a second cell of a first UL transmission after the guard period.

20. The UE of claim 12, wherein the first gap and the second gap include a guard period between UL transmissions and DL transmissions, the guard period being determined to be at least a maximum round trip time (RTT) across a plurality of cells served by a satellite.

21. The UE of claim 12, wherein a duration of DL transmission is one of fixed and dynamically configured.

22. The UE of claim 12, wherein the UL-DL configuration is defined for a narrow band Internet of things (NB-IoT) frame structure.

23. A method performed by a satellite based network node (26) in a non-terrestrial satellite communication network configured to serve a plurality of user equipments (UEs) for a radio access technology using time division duplex, the method comprising:
transmitting an uplink-downlink (UL-DL) configuration to configure a set of back-to-back DL subframes followed by a first gap encompassing one or more radio frames, and a set of back-to-back UL subframes followed by a second gap encompassing one or more radio frames, the set of back-to-back DL subframes and the first gap configured to alternate with the set of back-to-back UL subframes and the second gap every n-th radio frame; and
transmitting DL transmissions and receiving UL transmissions in accordance with the UL-DL configuration.

24. The method of claim 23, wherein the first and second gaps include a guard period between DL transmissions to a plurality of cells and UL transmissions from the plurality of cells.

25. The method of claim 24, wherein an order in which cells and UEs (22) are configured for the DL and UL transmissions is determined to minimize the guard period between the DL transmissions and the uplink transmissions.

26. The method of claim 23, wherein the UL-DL configuration is defined for a narrow band Internet of things (NB-IoT) frame structure.

27. A satellite based network node in a non-terrestrial satellite communication network configured to serve a plurality of user equipments (UEs) for a radio access technology using time division duplex, the network node (26) comprising processing circuitry configured to:
transmit an uplink-downlink (UL-DL) configuration to configure a set of back-to-back DL subframes followed by a first gap encompassing one or more radio frames, and a set of back-to-back UL subframes followed by a second gap encompassing one or more radio frames, the set of back-to-back DL subframes and the first gap configured to alternate with the set of back-to-back UL subframes and the second gap every n-th radio frame; and
transmit DL transmissions and receive UL transmissions in accordance with the UL-DL configuration.

28. The network node of claim 27, wherein the first and second gaps include a guard period between DL transmissions to a plurality of cells and UL transmissions from the plurality of cells.

29. The network node of claim 28, wherein an order in which cells and UEs are configured for the DL and UL transmissions is determined to minimize the guard period between the DL transmissions and the uplink transmissions.

30. The network node of claim 27, wherein the UL-DL configuration is defined for a narrow band Internet of things (NB-IoT) frame structure.
